(19) United States
(12) Patent Application Publication
(10) Pub. No.: US 2006/0177065 A1
(43) Pub. Date: Aug. 10, 2006

(54) System and methods for encrypting data utilizing one-time pad key

(75) Inventor: Scott L. Halbert, Rogers, AR (US)

Correspondence Address: TROUTMAN SANDERS LLP, 600 PEACHTREE STREET , NE, ATLANTA, GA, 30308, US

(73) Assignee: Wal-Mart Stores, Inc., Bentonville, AR (US)

(21) Appl. No.: 11/190,612

(22) Filed: Jul. 27, 2005

Related U.S. Application Data
(60) Provisional application No. 60/651,454, filed on Feb. 9, 2005.

(51) Int. Cl. H04L 9/00

(52) U.S. Cl. 380/277

(57) ABSTRACT

A system and methods for encrypting and decrypting data within an encryption management system. A random number table is generated by concatenating true random numbers. A subset of the random number table is then randomly selected to be used for the generation of a one-time pad key. The one-time pad key is generated by first retrieving random bytes of data from the subset of the random number table using a random offset value and a randomizer value. The retrieved bytes are concatenated together to form the one-time pad key. An exclusive-OR (XOR) operator is applied to the received input data with the one-time pad key to produce an encrypted value representation of the received input data. The random offset value and the randomizer value are stored with the encrypted value, so that the one-time pad key may be subsequently reproduced and used to decrypt the encrypted value.

### CROSS REFERENCE TO RELATED APPLICATION

This application claims the benefit of U.S. Provisional Application 60/651,454, filed on Feb. 9, 2005.

### TECHNICAL FIELD

The present invention relates, generally, to an encryption system, and, more particularly, to an encryption system utilizing a one-time pad key.

### BACKGROUND OF THE INVENTION

Secure management of personal information, especially credit card and account numbers, is increasingly important for data transfer between computer systems and for storage thereon. To prevent third-party access to personal information, companies and business have invested significant resources in providing access protection to computer systems and also to the data stored on and transferred between the computer systems. One of the most common and effective solutions for protecting personal or confidential information is the use of encryption technology.

In general terms, encryption technology provides for the transforming of intelligible information (also known as plain-text) to unintelligible data (also known as cyphertext). Although a variety of encryption techniques exist which offer varying degrees of security, the most common form of encryption provides a symmetric cryptographic algorithm where the same encryption key is used for encrypting and decrypting data. Symmetric cryptographic algorithms have been in use for centuries and include the famous Caesar Cipher, which simply used alphabetic substitution to encrypt and decrypt messages. Today, computer systems have become the dominate environment for data management and data communications. Current encryption practices, therefore, have been adapted for, and have benefited from, implementation on these computer systems.

A simple, yet effective, encryption technique for use with computer systems combines a bitwise Boolean operator, the XOR logic operator, with a one-time pad key. The XOR operator provides an effective mechanism for implementing a one-time pad key, as the result of the XOR operator applied to the plain-text data and the one-time pad key is completely unintelligible data. Additionally, applying the XOR operation to the unintelligible data and the one-time pad key will result in the original plain-text data. The strength, however, of this encryption technique depends upon a carefully crafted and unique key selection and management methodology.

Generating an effective one-time pad key is inherently difficult, because the same one-time pad key used for encrypting data must also be used for decrypting data. Accordingly, the one-time pad key must be available or reproducible for both the encryption and decryption processes. Additionally, business demands require that the encryption management system utilizing the one-time pad key be highly efficient and generated at a low cost. To minimize changes that must be made to existing applications within the computer systems, the encryption management system must produce encrypted output having the same data length as the original input, while avoiding certain “special characters.”

Accordingly, there is a need in the art for an encryption management system utilizing a one-time pad key for securing large volumes of data.

There is also a need in the art for an encryption managements system that provides a unique key selection methodology that is highly efficient and cost-effective.

Additionally, there is a need in the art for an encryption management system that produces encrypted output having the same data length as the original input, while avoiding certain “special characters.”

### SUMMARY OF THE INVENTION

Generally described, the present invention comprises a system and methods for encrypting and decrypting data within an encryption management system. Plain-text input data is encrypted by applying a Boolean exclusive-OR (XOR) operation to the plain-text input data and a randomly generated one-time pad key. The one-time pad key is generated by concatenating bytes of data randomly retrieved from a random number table. More specifically described, a random number table is generated by concatenating true random numbers. A subset of the random number table is then randomly selected to be used for the generation of the one-time pad key. The one-time pad key is generated by first retrieving random bytes of data from the subset of the random number table and concatenating the retrieved bytes together to form the one-time pad key. To introduce randomness when retrieving bytes of data from the subset of the random number table, a random offset value and randomizer value are used. The random offset value is a random number between zero and the number of bytes within the subset of the random number table. The random offset value is used to determine the first byte to retrieve from the subset of the random number table when generating the one-time pad key. The randomizer value is another random number used to determine the location (e.g., moving forward or backward within the subset) of the next byte to retrieve from the subset of the random number table. An XOR operator is then applied to the received input data with the one-time pad key to produce an encrypted value representation of the received input data. The random offset value and the randomizer value are stored with the encrypted value, so that the one-time pad key may be reproduced at a later time to be used to decrypt the encrypted value. Applying an XOR operator to the one-time pad key and the encrypted value produces the originally received input data.

To further provide security within the encryption management system, the random number table and the subset thereof are encrypted using an encryption key before being stored in non-volatile memory. A separate subset of the random number table is selected for each communication device needing to encrypt confidential data. If any subset of the random number table is compromised, then a new subset of the random number table is selected, while all of the encrypted data associated with the compromised subset is decrypted and then encrypted using the newly selected subset of the random number table. The section of the random number table representing the compromised subset is then marked as invalid so that it will not be subsequently selected for use by the encryption management system.

If the received input data comprises numeric characters, the encryption management system formats the encryption value (resulting from an XOR operation of the received input data and a generated one-time pad key) by “funny packing” the data. When a string of characters are represented in hexadecimal format, all numeric characters have a common high order nibble. Accordingly, the high order nibbles of the hexadecimal representation of the numeric characters can be ignored and all of the low order nibbles can be shifted as far right as possible (hence the name “funny packing”), so that all of the low order nibbles now reside as high and low order nibbles of the right half of the encrypted data. Such a shift in the low order nibbles frees the leftmost half of the encrypted data string. The leftmost half of the encrypted data may then be used for storing the random offset value and the randomizer value. Further, a set of bit flags may also be stored in the leftmost half of the encrypted value and be used to indicate when a special character has been replaced with a corresponding replacement value.

Other features and advantages of the present invention will become apparent upon reading and understanding the present specification when taken in conjunction with the appended drawings.

### BRIEF DESCRIPTION OF DRAWINGS

FIG. 1 displays a block diagram representation of an encryption management system in accordance with some embodiments of the present invention.

FIG. 2 displays a block diagram representation of a computing environment which may be utilized in accordance with some embodiments of the encryption management system of the present invention.

FIG. 3 displays a block diagram representation of a communication device of the encryption management system utilized to manage encryption of a subset of data in accordance with some embodiments of the present invention.

FIG. 4 displays a block diagram representation of a master random number table including subsets of a predetermined size in accordance with some embodiments of the present invention.

FIG. 5 displays a block diagram representation of a random number table including a subset of the master random number table in accordance with some embodiments of the present invention.

FIG. 6 displays a logic flow diagram representing a method of generating a master random number table in accordance with some embodiments of the present invention.

FIG. 7 displays a logic flow diagram representing a method of generating a random number table in accordance with some embodiments of the present invention.

FIGS. 8A-8E, collectively known as FIG. 8, display a logic flow diagram representing a method of encrypting input data utilizing a one-time pad key in accordance with some embodiments of the present invention.

FIGS. 9A-9D, collectively known as FIG. 9, display a logic flow diagram representing a method of formatting data after encryption in accordance with some embodiments of the present invention.

FIGS. 10A-10B, collectively known as FIG. 10, display a logic flow diagram representing a method of decrypting stored data utilizing a one-time pad key in accordance with some embodiments of the present invention.

FIG. 11 displays a logic flow diagram representing a method of invalidating a store random number table in accordance with some embodiments of the present invention.

### DETAILED DESCRIPTION OF THE INVENTION

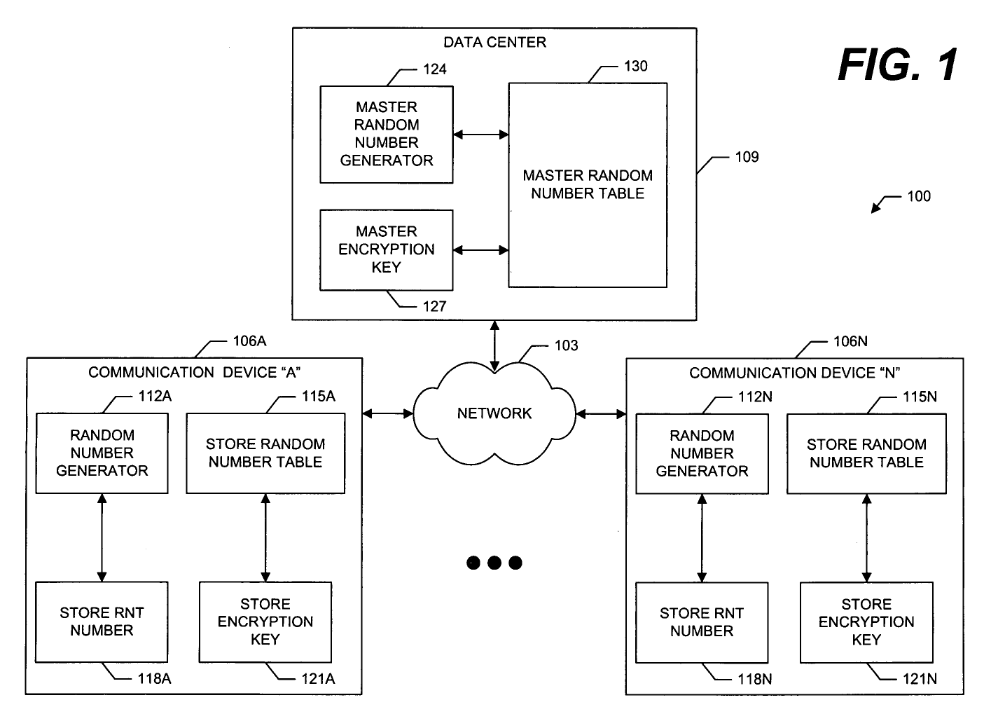

Referring now to the drawings, in which like numerals represent like components or steps throughout the several views, FIG. 1 displays a block diagram representation of an encryption management system 100 in accordance with some embodiments of the present invention. The encryption management system 100 comprises a data center 109 and a number of communication devices 106A-106N connected together via a communication network 103 (i.e., also referred to herein as a “network 103”). One skilled in the art will recognize that the network 103 typically contains the infrastructure and facilities appropriate to connect a group of two or more communication devices 106A-106N (including, without limitation, a number of computer systems in communication with each other), along with the data center 109. The network 103, data center 109, and communication devices 106A-106N may be configured in multiple network topologies including, but not limited to, star, bus, or ring configurations. Also, the network 103, data center 109, and communication devices 106A-106N may be broadly categorized as belonging to a particular architecture including, but not limited to, peer-to-peer or client/server architectures. The network 103 may additionally be classified by the geographical location of the communication devices 106A-106N and the types thereof. For example, if the network 103 connects a number of computer systems or servers located in relatively close proximity to each other, such as within a building, the network 103 is referred to as a local-area network (LAN). If the computer systems are located farther apart, the network 103 is generally referred to as a wide-area network (WAN), such as the Internet. If the computer systems are located within a limited geographical area, such as a university campus or military establishment, the network 103 is referred to as a campus-area network (CAN). Similarly, if the computer systems are connected together within a city or town, the network 103 is referred to as a metropolitan-area network (MAN). Finally, if the computer systems are connected together within a user's home, the network 103 is referred to as a home-area network (HAN).

The number of communication devices 106A-106N within the encryption management system 100 may vary depending on the requirements of the encryption management system 100. In one embodiment of the present invention, the number of communication devices 106A-106N corresponds to the number of retail stores utilizing point of sale systems connected to the data center 109. The data center 109 and the communication devices 106A-106N connect to the network 103 and, therefore, connect the data center 109 with each store. The data center 109 and each communication device 106A-106N, through use of a network interface and other appropriate hardware and software components, connect to the network 103 for bi-directional communication of signals and data therewith and, therefore, connect communicatively to each other for the bi-directional communication of signals and data therewith.

In one embodiment of the present invention, the data center 109 includes a master random number generator 124, a master random number table 130, and a master encryption key 127. While the data center 109 may comprise all of the aforementioned components, one skilled in the art will recognize that the aforementioned components may reside on separate computer devices at separate data centers within a distributed system. The master random number generator 124 is adapted to generate true random numbers, as opposed to pseudo-random numbers, of various sizes or lengths. The generated true random numbers may be concatenated together and stored in the master random number table (MRNT) 130. The MRNT 130 may include a memory device, which is capable of storing and retrieving data. The memory device may include, but is not limited to, volatile and/or non-volatile memory. The master encryption key 127 is a predetermined encryption key that may be used to effectively encrypt the data within the MRNT 130. One skilled in the art will recognize that various encryption techniques exist for the encryption of MRNT 130. For example, the MRNT 130 may be encrypted using the Integrated Cryptographic Service Facility (ICSF) provided by International Business Machines (IBM®), with the master encryption key 127 securely held in the hardware security module (HSM) on the data center's 109 peripheral component interconnect extended cryptographic coprocessor (PCIXCC), and the encrypted MSRT 130 stored in a file protected by the resource access control facility (RACF®) security subsystem of the data center 109.

Each communication device 106A-106N comprises a random number generator 112A-112N, a store random number table (RNT) number 118A-118N, a store encryption key 121A-121N, and a store random number table (SRNT) 115A-115N (e.g., a subset of the MRNT). The random number generator 112A-112N generates random numbers (e.g., true random numbers or pseudo-random numbers) of various sizes and lengths. More particularly, the random number generator 112A-112N generates a random number that has a value between zero and one less than a predetermined number, which is then stored as the store RNT number 118A-118N. Generally, the predetermined number is equal to the length of the MRNT 130 divided by the length of the SRNT 115A-115N. For example and not limitation, the MRNT 130 may have a length equal to the predetermined number multiplied by the length of the SRNT 115A-115N. If, for example, the length of the SRNT 115A-115N is 20,000 bytes (20 Kb) and the predetermined number is 4096, then the MRNT 130 would be created with a length equal to 4096 multiplied by 20,000 bytes (resulting in a value equal to 81.9 megabytes). The predetermined number, therefore, indicates the number of subsets of the MRNT 130 having a length equal to the desired length of SRNT 115A-115N.

The communication device 106A-106N for a given store communicates with the data center 109 to retrieve a subset of the MRNT 130 corresponding to the store RNT number 118A-118N. The retrieved subset of the MRNT 130 is stored within the communication device 106A-106N as the SRNT 115A-115N. The SRNT 115A-115N may include a memory device capable of storing and retrieving data. The memory device may include, but is not limited to, volatile memory and/or non-volatile memory. The store encryption key 121A-121N is a predetermined encryption key that may be used to effectively encrypt the data within the SRNT 115A-115N. For example, the store encryption key 121A-121N may contain an obfuscated key that resides in a separate or remote location (e.g., on a separate disk drive or on an HSM card) from the SRNT 115A-115N.

One skilled in the art will recognize that elements of the encryption management system 100, discussed above, may be connected through any appropriate communication channels that allow for bi-directional communication of signals and/or data. Such communication channels include, but are not limited to, analog, digital, wired and wireless communication channels. The communication channels may be copper wire, optical fiber, radio frequency (RF), infrared, satellite, and the like.

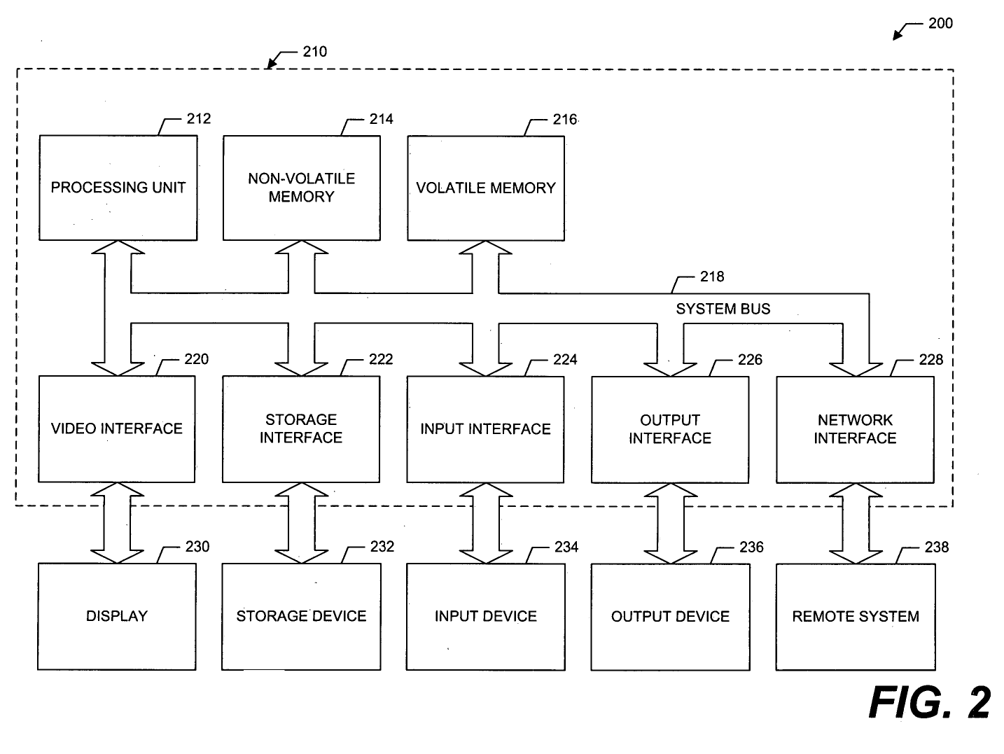

FIG. 2 displays a block diagram representation of a computing environment 200 which may be utilized in accordance with some embodiments of the encryption management system 100 of the present invention. More particularly, communication devices 106A-106N may use the computing environment 200 described herein. Communication devices 106A-106N of the encryption management system 100 may include, but are not limited to, personal computers, mainframe computers, servers, hand-held or laptop devices, multiprocessor systems, microprocessor-based systems, set-top boxes, programmable consumer electronics, network PCs, minicomputers, distributed computing environments that include any of the above systems or devices, and the like. It should be understood, however, that the features and aspects of the encryption management system 100 may be implemented by or into a variety of systems and system configurations and any examples provided within this description are for illustrative purposes only.

FIG. 2 and the following discussion provide a general overview of a platform onto which an embodiment of the present invention, or portions thereof, may be integrated, implemented and/or executed. Although reference has been made to instructions within a software program being executed by a processing unit, those skilled in the art will understand that at least some of the functions performed by the software may also be implemented by using hardware components, state machines, or a combination of any of these techniques. In addition, a software program which may implement an embodiment of the present invention may also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that may be compiled into such, and executed by a processing unit 212.

Turning now to the figure, computing device 210 may comprise various components including, but not limited to, a processing unit 212, a non-volatile memory 214, a volatile memory 216, and a system bus 218. The non-volatile memory 214 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), compact disc read only memory (CDROM), digital versatile disc (DVD), or other optical disk storage, magnetic cassettes, magnetic tape, magneto-optical storage devices, magnetic disk storage or other magnetic storage devices, or any other medium which may be used to store the desired information. The non-volatile memory 214 may provide storage for power-on and reset routines (bootstrap routines) that are invoked upon applying power or resetting the computing device 210. In some configurations the non-volatile memory 214 may provide the basic input/output system (BIOS) routines that are utilized to perform the transfer of information between elements within the various components of the computing device 210.

The volatile memory 216 may include a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 may provide temporary storage for routines, modules, functions, macros, data, etc. that are being or may be executed by, or are being accessed or modified by, the processing unit 212.

Alternatively, the non-volatile memory 214 and/or the volatile memory 216 may be a remote storage facility accessible through a distributed network system. Additionally, the non-volatile memory 214 and/or the volatile memory 216 may be a memory system comprising a multi-stage system of primary and secondary memory devices, as described above. The primary memory device and secondary memory device may operate as a cache for each other or the second memory device may serve as a backup to the primary memory device. In yet another embodiment, the non-volatile memory 214 and/or the volatile memory 216 may comprise a memory device configured as a simple database file or as a searchable, relational database using a query language, such as SQL.

The computing device 210 may access one or more external display devices 230 such as a CRT monitor, LCD panel, LED panel, electro-luminescent panel, or other display device, for the purpose of providing information or computing results to a user. In some embodiments, the external display device 230 may actually be incorporated into the product itself. For example, the computing device 210 may be a mobile device having a display device 230. The processing unit 212 may interface to each display device 230 through a video interface 220 coupled to the processing unit 210 over the system bus 218.

In operation, the computing device 210 sends output information to the display 230 and to one or more output devices 236 such as a speaker, modem, printer, plotter, facsimile machine, RF or infrared transmitter, computer or any other of a variety of devices that may be controlled by the computing device 210. The processing unit 212 may interface to each output device 236 through an output interface 226 coupled to the processing unit 212 over the system bus 218.

The computing device 210 may receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention may be stored in the non-volatile memory 214, the volatile memory 216, or in a remote memory storage device accessible through the output interface 226 and the input interface 224. The program modules may include an operating system, application programs, other program modules, and program data. The processing unit 212 may access various portions of the program modules in response to the various instructions contained therein, as well as under the direction of events occurring or being received over the input interface 224.

The computing device 210 may provide data to and receive data from one or more other storage devices 232, which may provide volatile or non-volatile memory for storage and which may be accessed by computing device 210. The processing unit 212 may interface to each storage device 232 through a storage interface 222 over the system bus 218.

The interfaces 220, 222, 224, 226, and 228 may include one or more of a variety of interfaces, including but not limited to, cable modems, DSL, T1, T3, optical carrier (e.g., OC-3), V-series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, and the like.

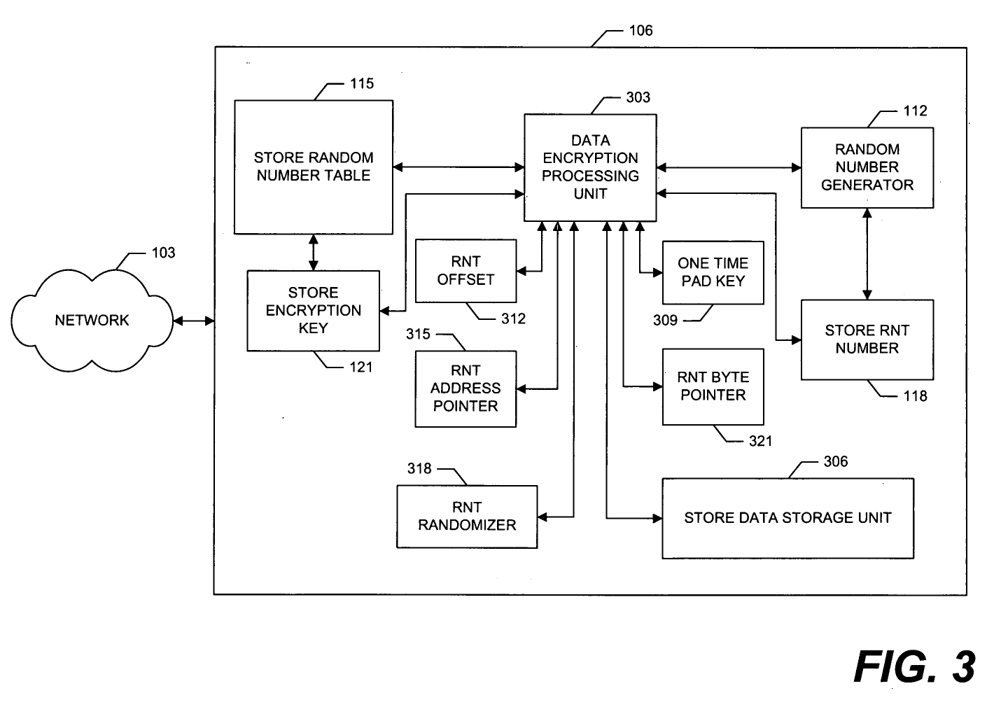

FIG. 3 displays a block diagram representation of the communication device 106 of the encryption management system 100 utilized to manage encryption of a subset of data in accordance with some embodiments of the present invention. The communication device 106 may represent a retail store utilizing a point of sale (POS) device and, therefore, the data stored within the communication device 106 may include confidential account numbers and/or payment information such as credit card numbers. To adequately secure this data, the communication device 106 may further comprise a data encryption processing unit 303, a RNT offset 312, a RNT address pointer 315, a RNT randomizer 318, a one-time pad key 309 (also referred to herein as an encryption key 309), a RNT byte pointer 321, and a store data storage unit 306.

The RNT offset 312, the RNT address pointer 315, the RNT randomizer 318, the one-time pad key 309, the RNT byte pointer 321, and the store data storage unit 306 may include a memory device capable of storing and retrieving data including, but not limited to, volatile memory 216 and/or non-volatile memory 214

The data encryption processing unit 303 is configured with hardware and/or software appropriate to perform tasks and provide capabilities and functionality as described herein. The data encryption processing unit 303 communicates with the store encryption key 121 and the SRNT 115. Initially, the data encryption processing unit 303 decrypts the SRNT 115 using the store encryption key 121 and then loads the decrypted SRNT 115 into volatile memory 216 (not shown). In one embodiment of the present invention, only the encrypted SRNT 115 is stored in permanent memory, such as non-volatile memory 214. Accordingly, the decrypted SRNT 115 resides in volatile memory 216 which increases both access time and security. Once the decrypted SRNT 115 is loaded into memory, the data encryption processing unit 303 stores the memory address (or storage address) of the first byte (e.g., the beginning) of the SRNT 115 as RNT address pointer 315.

Input data (e.g., an account number or credit card number) may be received from the store data storage unit 306 or from an external source such as a POS device (not shown). Upon receiving input data for encryption, the data encryption processing unit 303 provides a request to the random number generator 112 to generate a random number having a value between zero and one less than the length of decrypted SRNT 115 (e.g., 20 Kb or 20,480 bytes) using the input data as a seed value for randomness. The data encryption processing unit 303 coverts the generated random number into a two-byte hexadecimal value, which is stored as RNT offset 312 in the volatile memory 216.

The data encryption processing unit 303 then provides a request to the random number generator 112 to generate a random number having a value between zero and one less than a predetermined number. Typically, the predetermined number is the maximum size of the input data (e.g., 256 bytes). The data encryption processing unit 303 converts the generated random number into a one-byte hexadecimal value, which is stored as RNT randomizer 318 in the volatile memory 216.

The data encryption processing unit 303 uses the RNT offset 312, the RNT address pointer 315, and the RNT randomizer 318 to generate a one-time pad key 309 from the decrypted SRNT 115. More specifically, the data encryption processing unit 303 adds the value of RNT offset 312 with the value of RNT address pointer 315 and stores the result as RNT byte pointer 321. Because RNT address pointer 315 represents the memory address of the first byte (e.g., beginning) of the decrypted SRNT 115 and because the RNT offset 312 provides a random offset value (e.g., a value between zero and one less than the length of SRNT 115), the RNT byte pointer 321 corresponds to a random location within the decrypted SRNT 115. The data encryption processing unit 303 retrieves a byte of data from the decrypted SRNT 115 located at the memory address represented by RNT byte pointer 321. The retrieved byte of data is then stored by the data encryption processing unit 303 as the first byte of the one-time pad key 309.

To introduce more randomness to the generation of the one-time pad key 309, the data encryption processing unit 303 applies a Boolean XOR operation to the retrieved byte of data with the value of the RNT randomizer 318. If the high order nibble of the result is odd, then the data encryption processing unit 303 subtracts the value of the retrieved byte from the value of the RNT byte pointer 321. If the high order nibble of the result is even, then the data encryption processing unit 303 adds the value of the retrieved byte to the value of the RNT byte pointer 321. The data encryption processing unit 303 then adds the value of RNT randomizer 318 to the incremented or decremented value of the RNT byte pointer 321. The result is then stored as the RNT byte pointer 321 in volatile memory 216.

To ensure that RNT byte pointer 321 does not point to a memory address or location before the beginning of the decrypted SRNT 115, the data encryption processing unit 303 determines whether the value of the RNT byte pointer 321 is less than the value of the RNT address pointer 315. If the value of the RNT byte pointer 321 is less than the value of the RNT address pointer 315, then the data encryption processing unit 303 adds the length of the decrypted SRNT 115 to the RNT byte pointer 321. Similarly, to ensure that RNT byte pointer 321 does not point to a memory address or location after the end of the decrypted SRNT 115, the data encryption processing unit 303 determines whether the value of the RNT byte pointer 321 is greater than the sum of the value of the RNT address pointer 315 and the length of the decrypted SRNT 115. If the value of the RNT byte pointer is greater than the sum of the value of the RNT address pointer 315 and the length of the decrypted SRNT 115, then the data encryption processing unit 303 subtracts the length of the decrypted SRNT 115 from the RNT byte pointer 321. Incrementing or decrementing the RNT byte pointer 321 effectively allows the RNT byte pointer 321 to “wrap around” the decrypted SRNT 115 when necessary.

The data encryption processing unit 303 then retrieves another byte of data from the decrypted SRNT 115 located at the memory address represented by RNT byte pointer 321. The retrieved byte of data is then concatenated to the end of the one-time pad key 309 by the data encryption processing unit 303. The data encryption processing unit 303 then repeats the process described above by applying a Boolean XOR operation to the retrieved byte of data and the value of the RNT randomizer 318. The data encryption processing unit 303 continues to retrieve random bytes of data from the decrypted SRNT 115 until the length (byte-size) of the one-time pad key 309 equals the length (byte-size) of the received input data (e.g., an account number or credit card number converted to a hexadecimal format).

The data encryption processing unit 303 then applies a Boolean XOR operation to the one-time pad key 309 and the received input data, which results in an encrypted value of the received input data. One skilled in the art will recognize that the XOR operation is an effective mechanism for implementing a one-time pad key 309, because the resulting output from an XOR operation produces an encrypted value that is unintelligible without the one-time pad key 309. When the encrypted value is applied in an XOR operation with the one-time pad key 309, the result is the exact input data originally received by the data encryption processing unit 303. More specifically, the XOR operation compares each bit of received input data with each bit of the one-time pad key 309. If a bit of the received input data is equal to the corresponding bit of the one-time pad key 309, then the XOR operation results in a FALSE condition represented as a binary (or bit level) zero. If a bit of the received input data is not equal to the corresponding bit of the one-time pad key 309, then the XOR operation results in a TRUE condition represented as a binary (or bit level) one.

For example and not limitation, Tables 1-3 illustrate an XOR operation applied to an input data comprising the characters of “2,” “6,” “8”, and “9”, which are represented in ASCII hexadecimal as “32,” “36,” “38,” and “39” for a total of four bytes. The one-time pad key 309 contains the same number of bytes as the input data (in this example, four bytes). Accordingly, the one-time pad key 309 contains four randomly selected bytes having the values of “7A,” “D0,” “91,” and “EB.” As shown in Table 1, each character digit of the received input data is represented by a standard hexadecimal value, which can be converted into a binary value of eight bits (one byte). Table 2 illustrates the hexadecimal values of the one-time pad key 130 and the corresponding binary values.

TABLE 1
Input Data Representation (Example)
INPUT DATA

| | | | | |
|---|---|---|---|---|
| Character Digits | 2 | 6 | 8 | 9 |
| ASCII Hexadecimal | 32 | 36 | 38 | 39 |
| Binary Value of | 0011 0010 | 0011 0110 | 0011 1000 | 0011 1001 |
| ASCII Hexadecimal | | | | |

TABLE 2
One-Time Pad Key Representation (Example)
ONE-TIME PAD KEY

| | | | | |
|---|---|---|---|---|
| Hexadecimal | 7A | D0 | 91 | EB |
| Binary Value of | 0111 1010 | 1101 0000 | 1001 0001 | 1110 1011 |
| Hexadecimal | | | | |

Table 3 illustrates the result of applying an XOR operation to the binary value representation of the received input data and the binary value representation of the one-time pad key 309. Without the binary value representation of the one-time pad key 309, the binary value representation of the received input data cannot be determined from the binary value representation of the encrypted value (e.g., the result of the XOR operation).

TABLE 3
XOR of Input Data and One-Time Pad Key (Example)
XOR

| | | | | |
|---|---|---|---|---|
| Input Data (Binary | 0011 0010 | 0011 0110 | 0011 1000 | 0011 1001 |
| Value) | | | | |
| One-Time Pad Key | 0111 1010 | 1101 0000 | 1001 0001 | 1110 1011 |
| (Binary Value) | | | | |
| Encrypted Value | 0100 1000 | 1110 0110 | 1010 1001 | 1101 0010 |
| (Result of XOR) | | | | |

The data encryption processing unit 303 provides the encrypted value of the received input data, the store RNT number 118, the RNT offset 312, and the RNT randomizer 318 to the store data storage unit 306 for storage. When the data encryption processing unit 303 needs the original input data for processing, the data encryption processing unit 303 recreates the one-time pad key 309 from the decrypted SRNT 115, designated by the store RNT number 118, using the stored RNT offset 312 and RNT randomizer 318. The data encryption processing unit 303 then applies the XOR operation to the recreated one-time key pad 309 and the encrypted value to produce the originally received input data (decrypted value) in ASCII hexadecimal format.

In another embodiment of the present invention, the data encryption processing unit 303 formats the encrypted value into packed decimal format by shifting the “significant” data (e.g., the low order nibbles) to the right, resulting in a “funny packed” data format. For instance, one skilled in the art will recognize that if the received input data comprises numeric characters, then the high order nibble (first four bits) of each character of the input data (represented in a computer character format such as ASCII or EBCDIC) comprises “insignificant information.” As shown in Table 4, the high order nibble of each character digit always has a value of “3” in ASCII hexadecimal format or always a value of “F” in EBCDIC hexadecimal format. Consequently, the high order nibble of each character of the input data may be ignored.

TABLE 4
Standard Code Representation of Numeric Digits

Numeric

| | 0 | 1 | 2 | 3 | 4 | 5 | 6 | 7 | 8 | 9 |
|---|---|---|---|---|---|---|---|---|---|---|
| ASCII Hexadecimal | 30 | 31 | 32 | 33 | 34 | 35 | 36 | 37 | 38 | 39 |
| EBCDIC Hexadecimal | F0 | F1 | F2 | F3 | F4 | F5 | F6 | F7 | F8 | F9 |

*ASCII—American Standard Code for Information Interchange
*EBCDIC—Extended Binary-Coded Decimal Interchange Code

By knowing that the high order nibble of each character digit of the input data will be the same (e.g., either a “3” or an “F” in hexadecimal format), the high order nibble of the encrypted value can be ignored without losing the correct value. The high order nibble may be added back after the decryption process. As the high order nibble of each byte is ignored, the low order nibble of each byte (excluding the rightmost byte) can be shifted to the right, thus resulting in a “funny packing” of the data. The result, therefore, correctly represents the original data, but does so in half the data length (e.g., number of bytes). Returning to the example above, the input data “2689” represented by four bytes (in ASCII hexadecimal format) may be adequately represented in the two rightmost bytes, allowing the two leftmost bytes to be used for storage of the store RNT number 118A, the RNT offset 312, and the RNT randomizer 318.

Tables 5 and 6 summarize a “funny pack” of the encrypted value representing input data “2689.” Continuing with the example illustrated in Tables 1-3, Table 5 shows the hexadecimal values of the encrypted value resulting from applying an XOR operation to the binary value representation of the received input data and the binary value representation of the one-time pad key 309.

TABLE 5
Hexadecimal Representation of Encrypted Value (Example)

| | | | | |
|---|---|---|---|---|
| Encrypted Value | 0100 1000 | 1110 0110 | 1010 1001 | 1101 0010 |
| (Result of XOR) | | | | |
| Hexadecimal of | 48 | E6 | A9 | D2 |
| Encrypted Value | | | | |

In Table 6, the high order nibbles of each hexadecimal byte are ignored (e.g., zeroed out) and the remaining low order nibbles are shifted to the right, resulting in the use of only two bytes instead of the original four bytes. The unused leftmost two bytes may be used to store additional information, such as, but not limited to, the store RNT number 118A, the RNT offset 312, and the RNT randomizer 318.

TABLE 6
Funny Pack of Encrypted Value (Example)

| | | | | |
|---|---|---|---|---|
| Hexadecimal of Encrypted Value | 48 | E6 | A9 | D2 |
| Ignoring All High Order Nibbles | 08 | 06 | 09 | 02 |
| Shifting All Low Order Nibbles to the Right (Funny | 00 | 00 | 86 | 92 |
| Pack) | | | | |

The high order nibbles of the encrypted data are not significant and are not needed to decrypt the encrypted data, because the decrypted values for the high order nibbles will always be a “3” or an “F,” depending on the character set used (e.g., ASCII or EBCDIC). To ignore the high order nibbles of the encrypted data, the data encryption processing unit 303 moves the low order nibbles of the encrypted data to consecutive low order and high order nibble pairs. Initially, the data encryption processing unit 303 moves the low order nibble of byte 2 (counting from the right to the left) to the high order nibble of byte 1, replacing the insignificant high order nibble data of byte 1. Next, the data encryption processing unit 303 moves the low order nibble of byte 3 to the low order nibble of byte 2. Then, the data encryption processing unit 303 moves the low order nibble of byte 4 to the high order nibble of byte 2. The data encryption processing unit 303 continues to move all of the low order nibbles of each byte as far right as possible, until the rightmost half of the encrypted value is populated with the low order nibbles of each byte of the encrypted value, while the leftmost half is left empty (e.g., contains no significant data). The data encryption processing unit 303 then stores the store RNT number 118, the RNT offset 312, and the RNT randomizer 318 in the leftmost half of the encrypted data. Finally, the resulting packed encryption data is stored in the store data storage unit 306.

In yet another embodiment of the present invention, the data encryption processing unit 303 determines whether the encrypted value comprises any special characters prior to providing the encrypted value to the store data storage unit 306 for storage. Special characters may include, but are not limited to, new line characters, commas, binary zeros, and other commonly used data item delimiters. If the data encryption processing unit 303 determines that special characters exist within the encrypted value, the data encryption processing unit 303 replaces each special character with a predetermined corresponding replacement value. There exists a one-to-one relationship between the special characters and the predetermined replacement values. In other words, there exists only one unique, predetermined replacement value for each special character. Additionally, the data encryption processing unit 303 sets a corresponding bit flag (e.g., changes the bit flag from a “0” to a “1”) for each byte of the encrypted value that was replaced with a corresponding replacement value, which is stored in the store data storage unit 306 with the encrypted data.

To ensure that the encrypted data does not become corrupt, all predetermined replacement values range from 00 to 7F in hexadecimal format. This ensures that the eighth bit (counting from right to left) of the replacement value byte will be a zero. The eighth bit (or high bit) is reserved to indicate whether the first byte (counting from left to right) of the special character replacement bit flags is in fact a special character itself, after all of the appropriate bit flags have been turned on. If the first byte (counting from left to right) of the special character replacement bit flags is in fact a special character, then the eighth bit is set to one. During the decryption process, the eighth bit is evaluated to determine whether the first byte (counting from left to right) has been replaced by the replacement value corresponding with the special character. Typically, a set of bit flags, in addition to the store RNT number 118, the RNT offset 312, and the RNT randomizer 318, are stored in the leftmost bytes of the “funny packed” encrypted value, so if, for example, the third byte (counting from right to left) of the encrypted value has been replaced with a predetermined replacement value, then a third bit (counting from right to left) of the bit flags will be set. After replacing all of the special characters and setting the corresponding bit flags, the modified encrypted value is stored in the store data storage unit 306.

To decrypt an encrypted value stored in the store data storage unit 306, the data encryption processing unit 303 reverses the process for encrypting the received input data. The data encryption processing unit 303 determines whether any bit flags have been set and, if so, replaces the appropriate bytes with the correct special character values. If necessary, the data encryption processing unit 303 unpacks the “funny packed” encrypted value and incorporates the appropriate high order nibble for each byte (e.g., a “3” for ASCII and an “F” for EBCDIC). Next, the data encryption processing unit 303 retrieves the store RNT number 118, the RNT offset 312, and the RNT randomizer 318 from the encrypted value. Using the store RNT number 118, the RNT offset 312, and the RNT randomizer 318, the data encryption processing unit 303 recreates the one-time pad key 309 from the SRNT 115. Finally, the data encryption processing unit 303 applies an XOR operation to the recreated one-time pad key 309 and the encrypted value, which results in the original input data received and encrypted by the data encryption processing unit 303.

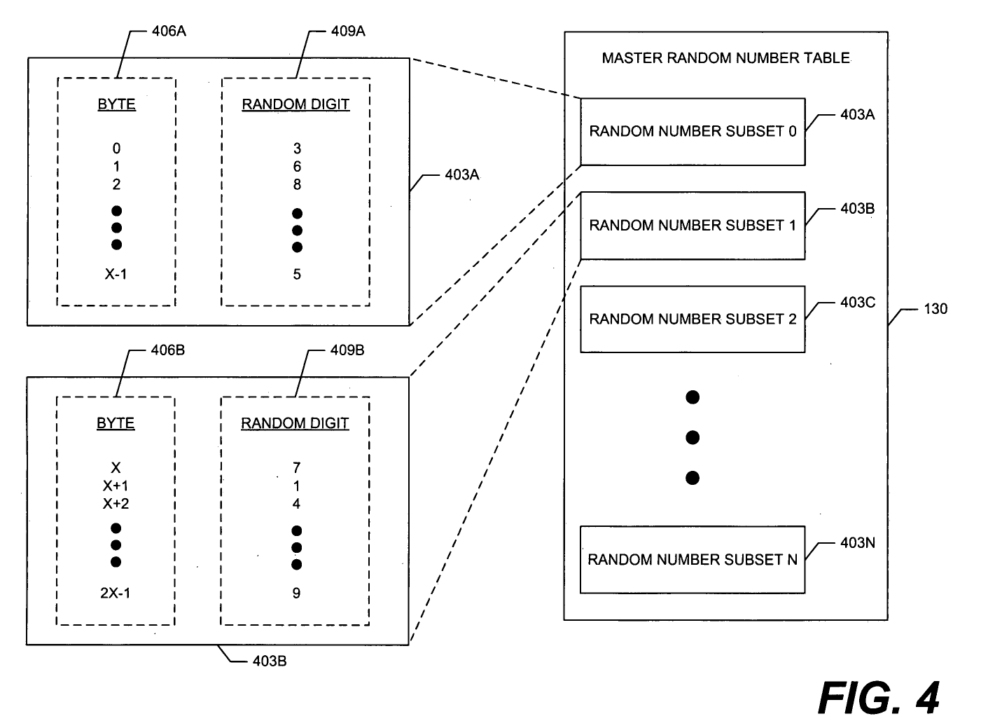

FIG. 4 displays a block diagram representation of a master random number table 130 including subsets 403A-403N of a predetermined size in accordance with some embodiments of the present invention. As described above, the master random number generator 124 (FIG. 1) generates true random numbers that are concatenated together and stored as the MRNT 130 (FIG. 1). The size or length of the MRNT 130 is generally a multiple of the predetermined size of the SRNT 115A-115N. Accordingly, the MRNT 130 comprises a plurality of subsets 403A-403N having a size equal to the predetermined size of the SRNT 115A-115N.

The store RNT number 118A-118N indicates the particular subset 403A-403N within the MRNT 130 to be retrieved and used as the SRNT 115A-115N, which corresponds to a particular store. The particular subset 403A-403N within the MRNT 130 is located at the byte of the MRNT 130 equal to the store RNT number 118A-118N multiplied by the predetermined size of the SRNT 115A-115N. More specifically, a random number generator 112A-112N generates a random number having a value between zero and one less than the number of subsets 403A-403N within the MRNT 130. The generated random number is stored as the store RNT number 118A-118N. Consequently, each communication device 106 may be using a different SRNT 115, which represents a randomly selected subset 403 of the MRNT 130.

Each subset 403A-403N within the MRNT 130 comprises a set of random digits 409A, 409B which correspond to a set of bytes 406A, 406B that indicate the location of each random digit within the MRNT 130. For example, subset 403A comprises a set of random digits 409A having a set of corresponding byte numbers 406A that begin with byte “0” and end with byte “X-1,” where “X-1” represents one less than the predetermined size of the SRNT 115A-115N. As illustrated in FIG. 4, byte “0” of subset 403A corresponds to random number “3,” byte “1” corresponds to random number “6,” byte “2” corresponds to random number “8,” and byte “X-1” corresponds to random number “5.”

When the communication device 106 retrieves the random number subset 403 from the MRNT 130 that corresponds to the store RNT number 118, the communication device 106 retrieves the set of random digits 409A, 409B from the random number subset 403 that begin at the byte equal to the store RNT number 118 multiplied by the predetermined size of the SRNT 115 and that end at the byte equal to one less than the sum of the predetermined size of the SRNT 115 and the product of the store RNT number 118 and the predetermined size of the SRNT 115.

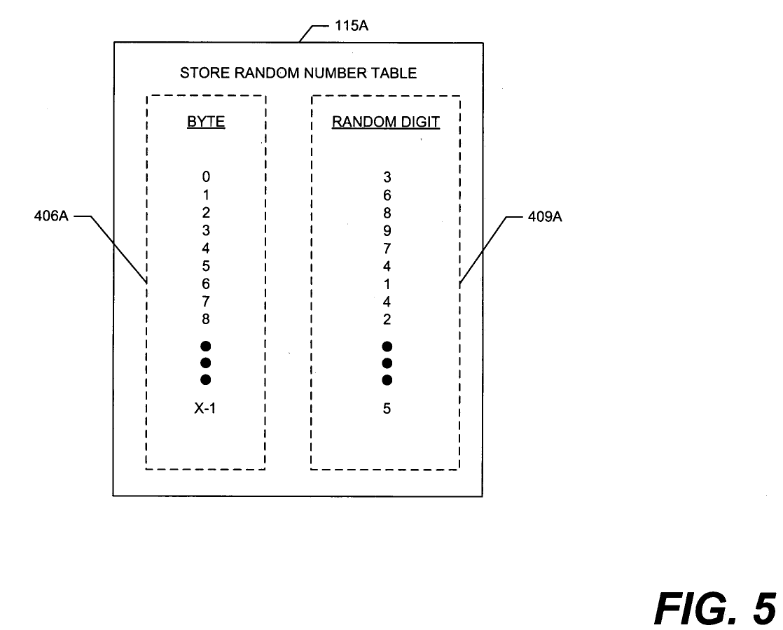

FIG. 5 displays a block diagram representation of a random number table 115 including a subset 403 of the master random number table 130 in accordance with some embodiments of the present invention. As described above, the random number generator 112 generates a random number that is designated as the store RNT number 118. The communication device 106 retrieves a subset 403 from the MRNT 130 via the network 103 that corresponds to the store RNT number 118. The retrieved subset 403 is designated as the SRNT 115 and will be used to generate a one-time pad key 309 when encrypting and decrypting data.

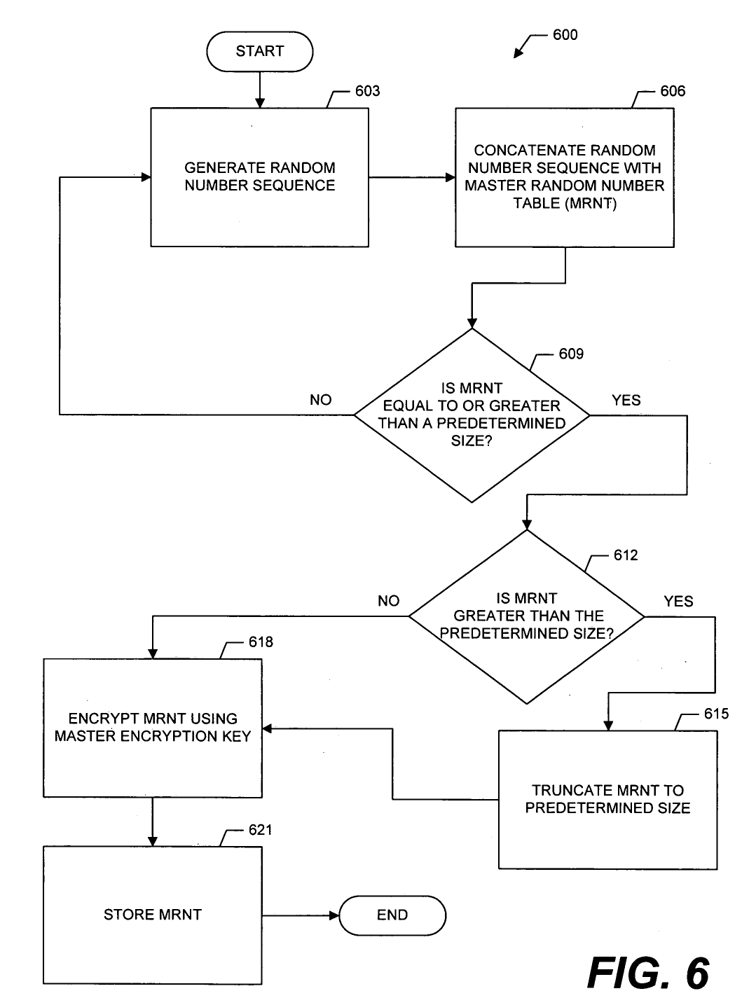

FIG. 6 displays a logic flow diagram representing a method 600 of generating a master random number table 130 in accordance with some embodiments of the present invention. Created at the data center 109, the master random number generator 124 generates true random numbers which are concatenated together to make the MRNT 130.

The method 600 of generating a MRNT 130 begins at 603 where the master random number generator 124 generates a true random number sequence. At 606, the generated true random number sequence is concatenated with the MRNT 130 (which is currently a null value). Next, at 609, a determination is made whether the size of the MRNT 130 is equal to or greater than a predetermined size (e.g., number of bytes). The predetermined size is typically a multiple of the desired length of the SRNT 115. In other words, the predetermined size equals the product of the desired length of the SRNT 115 and the number of subsets 403A-403N that the MRNT 130 will contain. If at 609 it is determined that the size of the MRNT 130 is equal to or greater than the predetermined size, then the method 600 proceeds to 612 where a determination is made whether the size of the MRNT 130 is greater than the predetermined size.

If at 612 it is determined that the size of the MRNT 130 is greater than the predetermined size, then the “YES” branch is followed to 615 where the MRNT 130 is truncated to the predetermined size (e.g., the MRNT 130 is shortened to the correct size). Next, at 618 the MRNT 130 is encrypted using the master encryption key 127. Then at 621, the MRNT 130 is stored in a memory device residing within the data center 109. The generation of the MRNT 130 is then terminated.

If, however, at 612 it is determined that the size of the MRNT 130 is not greater than the predetermined size, then the MRNT 130 equals the predetermined size and the “NO” branch is followed to 618 where the MRNT 130 is encrypted using the master encryption key 127. Then at 621, the MRNT 130 is stored in a memory device residing within the data center 109. For security purposes, only the encrypted MRNT 130 will be stored in non-volatile memory within the data center 109. The generation of the MRNT 130 is then terminated.

If, however, at 609 it is determined that the size of the MRNT 130 is not equal to or greater than the predetermined size, then the “NO” branch returns to 603, and a new true random number sequence is generated.

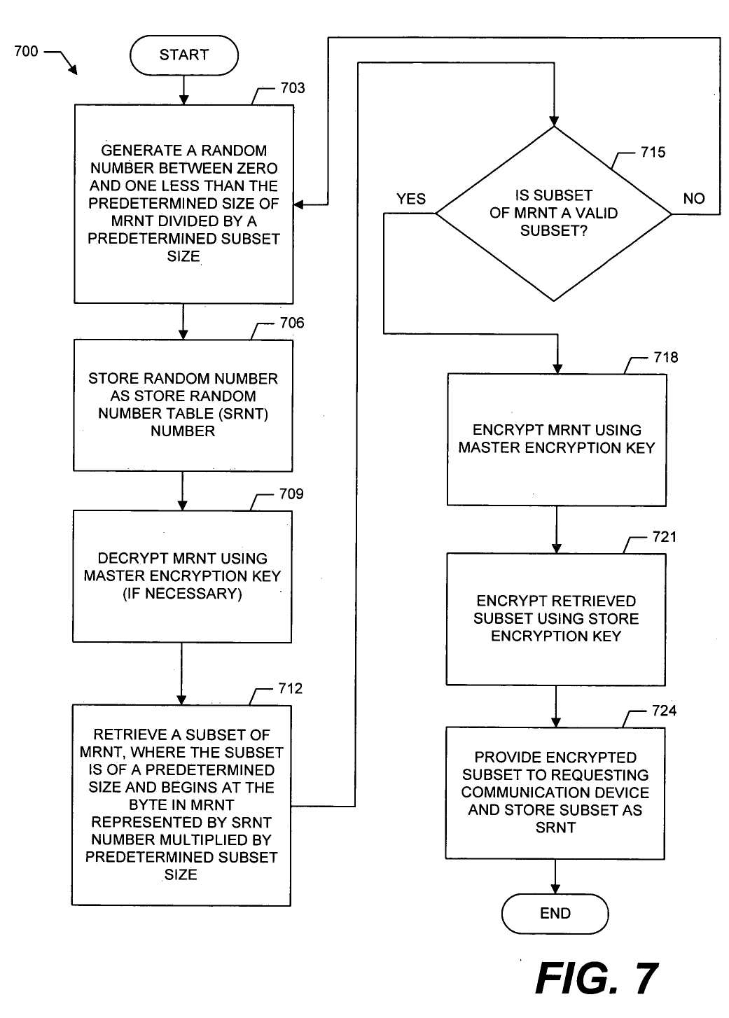

FIG. 7 displays a logic flow diagram representing a method 700 of generating a random number table 115 in accordance with some embodiments of the present invention. The communication device 106 connects to the data center 109 via the network 103 and retrieves one of the subset 403A-403N of the MRNT 130 that corresponds to the store RNT number 118. The retrieved subset 403 is then used by the communication device 106 as the SRNT 115.

The method 700 of generating a SRNT 115 begins at 703 where the random number generator 112 generates a random number having a value between zero and the number of subsets 403A-403N in MRNT 130 (e.g., generates a random number between zero and one less than the predetermined number of subsets 403A-403N (i.e., 4096) within the MRNT 130). At 706, the generated random number is stored as the store RNT number 118. Then, at 709, the MNT 130 is decrypted using the master encryption key 127 and the resulting decrypted MRNT 130 is stored into volatile memory 214. Next, at 712, the communication device 106 retrieves a subset 403A-403N of the MRNT 130 that corresponds to the store RNT number 118. In other words, the communication device 106 retrieves a subset 403A-403N of the MRNT 130 that begins at the byte in MRNT 130 corresponding to the value of the store RNT number 118 multiplied by the predetermined size of the SRNT 115 (e.g., the predetermined size of subset 403A-403N).

At 715, a determination is made whether the subset 403A-403N retrieved from the MRNT 130 is valid. Subsets 403A-403N within the MRNT 130 may be marked invalid, especially if a particular subset 403A-403N is known to be compromised or not secure. If at 715 it is determined that the retrieved subset 403 is valid, then “YES” branch is followed to 718 where the MRNT 130 is encrypted using the master encryption key 127 or is deleted from the volatile memory 216, if necessary. Next, at 721 the retrieved subset 403 is encrypted using the store encryption key 121 A. Then, at 724, the encrypted subset 403 is provided to the requesting communication device 106 and stored as the SRNT 115 in non-volatile memory 214. The generation of the SRNT 115 then terminates operation. If, however, at 715 it is determined that the retrieved subset 403 is not valid, then the “NO” branch is followed to 703, described above.

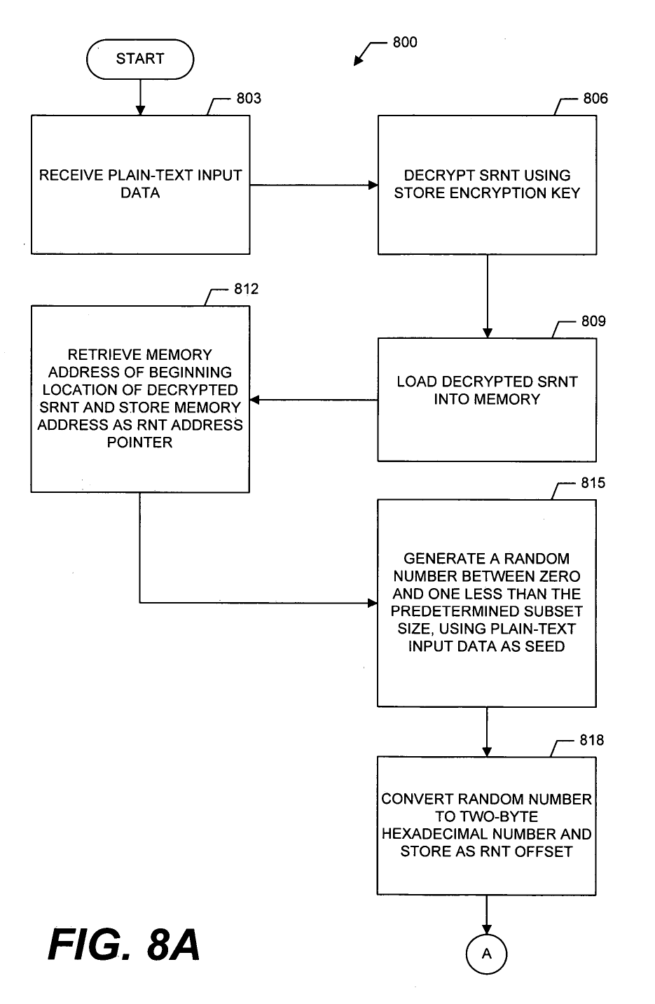

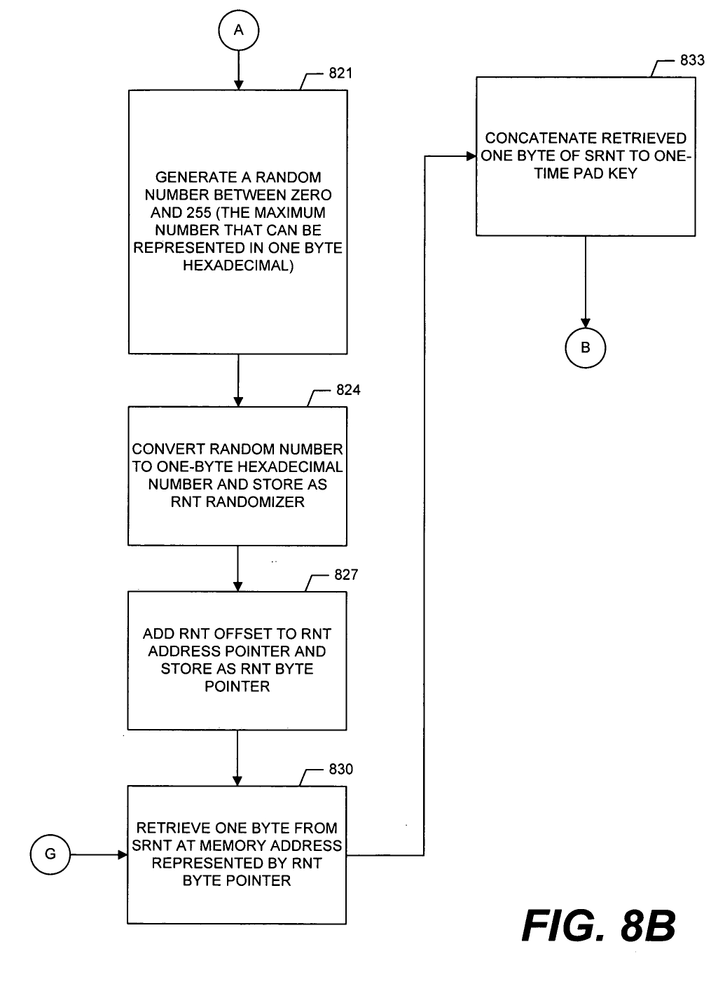

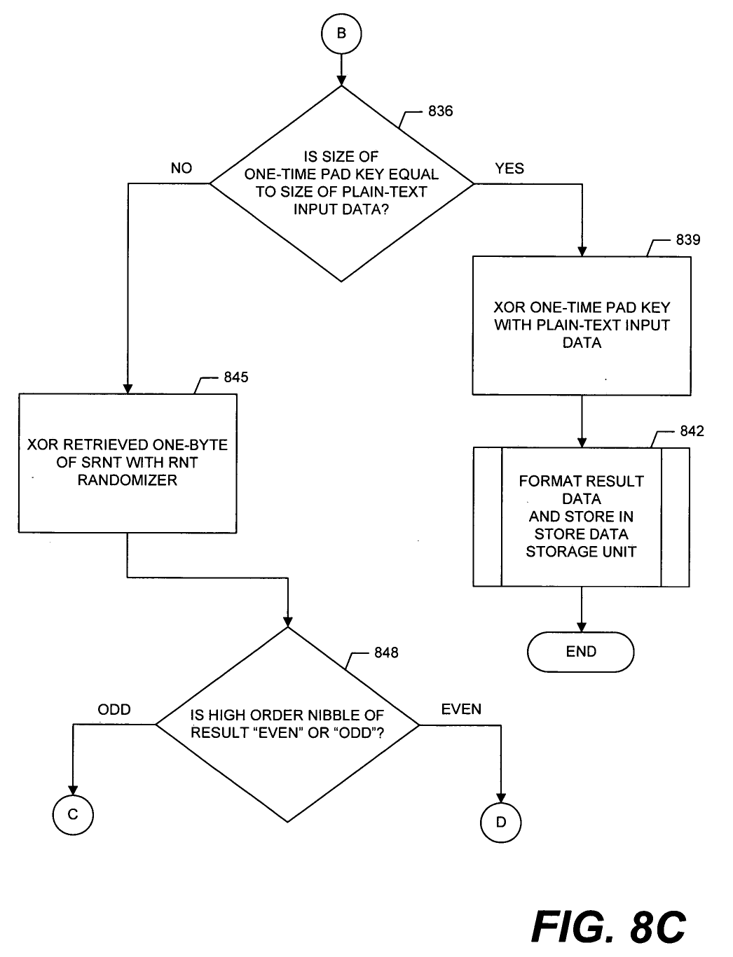

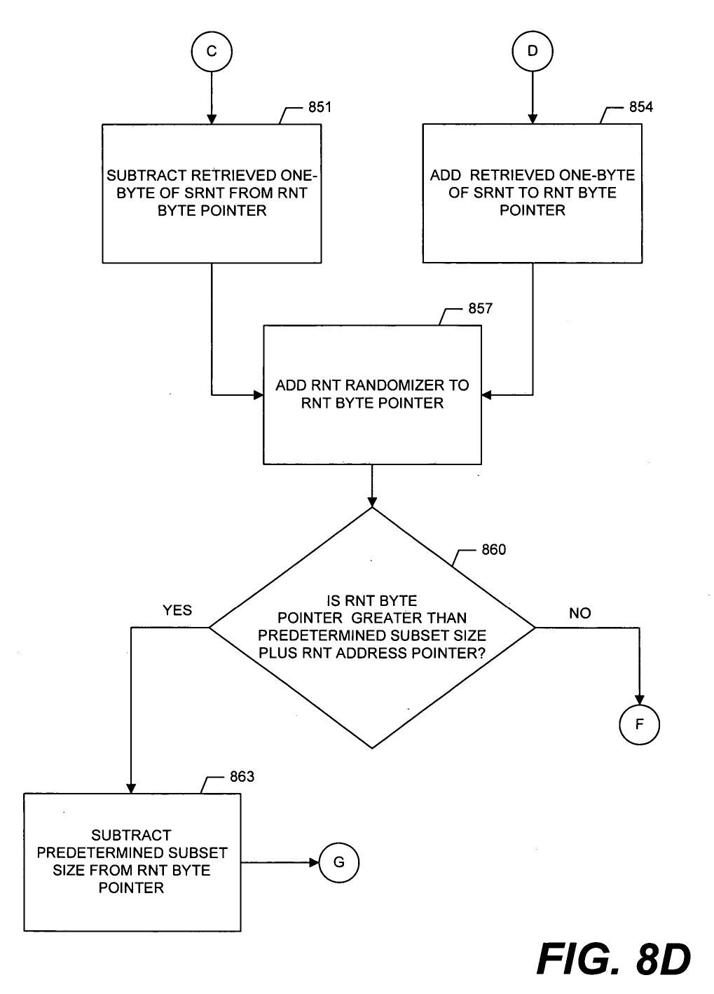

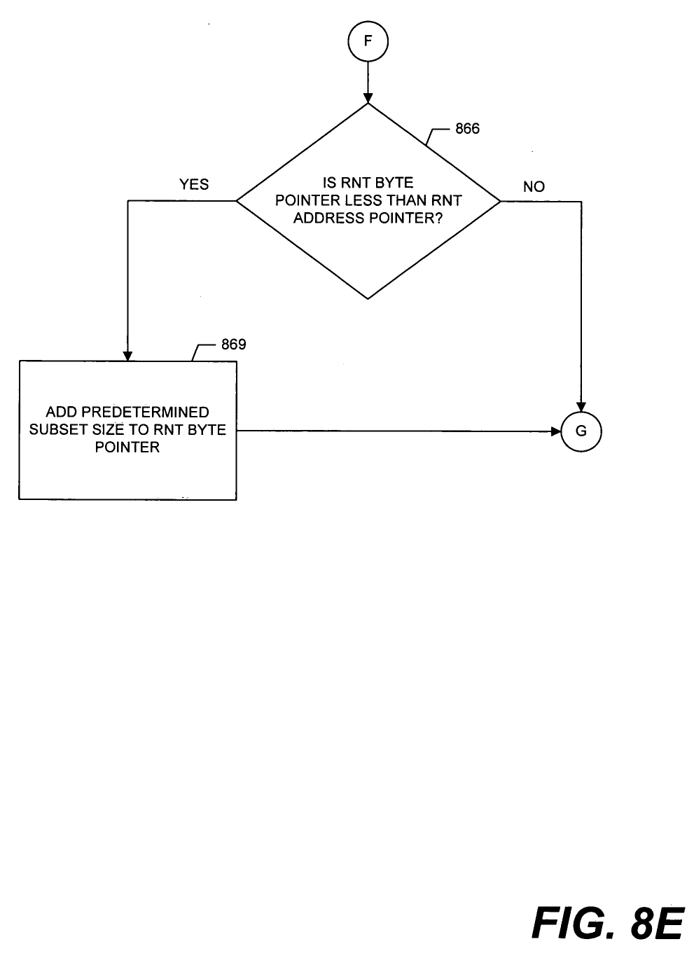

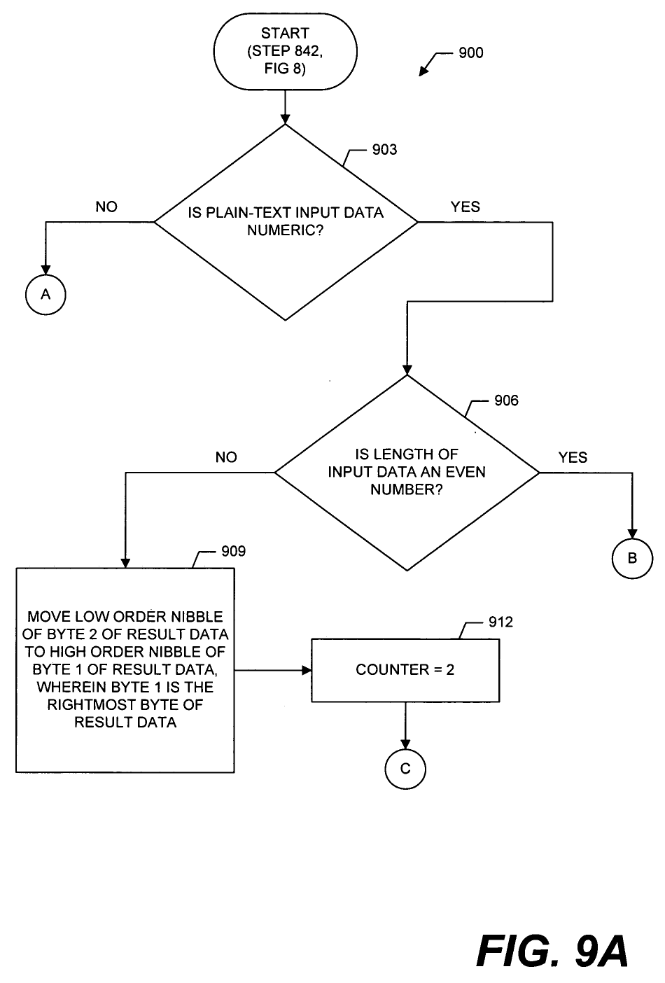

FIGS. 8A-8E, collectively known as FIG. 8, display a logic flow diagram representing a method 800 of encrypting input data utilizing a one-time pad key 309 in accordance with some embodiments of the present invention. Each communication device 106A-106N, which may represent a retail store utilizing a point of sale device, is capable of encrypting and decrypting data received by the point of sale device and/or stored in the store data storage unit 306. Using a one-time key pad 309 and the XOR operation, the data encryption processing unit 303 encrypts received input data for storage. Generation of the one-time key pad 309 involves a random selection of data within the SRNT 115A-115N.

The method 800 of encrypting input data utilizing a one-time pad key 309 begins at 803 where the data encryption processing unit 303 receives plain-text input data, such as an account number or a credit card number. At 806, the data encryption processing unit 303 decrypts the SRNT 115 using the store encryption key 121. At 809, the data encryption processing unit 303 loads the decrypted SRNT 115 into volatile memory 216. For security purposes, only the encrypted SRNT 115 is stored in non-volatile memory 214. Accordingly, if the encryption management system 100 is breached, then the only decrypted copy of the SRNT 115 will be in volatile memory 216, which is much more difficult to access. Next, at 812, the data encryption processing unit 303 retrieves the memory address of the beginning (e.g., first byte) location of the decrypted SRNT 115 and stores the retrieved memory address as the RNT address pointer 315 in volatile memory 216.

At 815, the random number generator 112 generates a random number having a value between zero and one less than the predetermined size of the SRNT 115, using the received plain-text input data as the seed for randomization. At 818, the data encryption processing unit 303 then converts the generated random number to a two-byte hexadecimal number and stores the result as the RNT offset 312. Next, at 821, the random number generator 112 generates a second random number having a value between zero and 255 (the maximum hexadecimal number that can be represented in one byte). Then, at 824, the data encryption processing unit 303 converts the second generated random number to a one-byte hexadecimal number and stores the result as the RNT randomizer 318. At 827, the data encryption processing unit 303 then adds the value of the RNT offset 312 with the value of the RNT address pointer 315 and stores the result as the RNT byte pointer 321.

At 830, the data encryption processing unit 303 retrieves one byte from the decrypted SRNT 115, where the one byte is located at the memory address identified by the RNT byte pointer 321. Next, at 833, the data encryption processing unit 303 concatenates the retrieved one byte of data from the SRNT 115 to the one-time pad key 309 (which initially is set to null). At 836, the data encryption processing unit 303 determines whether the size (in bytes) of the one-time pad key 309 equals the size (in bytes) of the received input data.

If, at 836, the data encryption processing unit 303 determines that the size (in bytes) of the one-time pad key 309 is equal to the size (in bytes) of the received input data, then the “YES” branch is followed to 839 where the data encryption processing unit 303 applies a Boolean XOR operation to the contents of the one-time pad key 309 and the input data. Next, at 842 the data encryption processing unit 303 formats, as necessary, the result of the XOR operation and stores the formatted results in the store data storage unit 306. Data encryption processing unit 303 then terminates operation in accordance with method 800.

If, however, at 836 the data encryption processing unit 303 determines that the size (in bytes) of the one-time pad key 309 does not equal the size (in bytes) of the input data, then the “NO” branch is followed to 845 where the data encryption processing unit 303 applies an XOR operation on the RNT randomizer 318 and the one byte of data retrieved from the SRNT 115. Then, at 848, the data encryption processing unit 303 determines whether the resulting high order nibble of the XOR operation is either “EVEN” or “ODD.” If, at 848, the data encryption processing unit 303 determines that the resulting high order nibble of the XOR operation is an “EVEN” value, then at 854 the data encryption processing unit 303 adds the value of the one byte of data retrieved from the SRNT 115 to the RNT byte pointer 321. If, however, at 848 the data encryption processing unit 303 determines that the resulting high order nibble of the XOR operation is an “ODD” value, then the data encryption processing unit 303 subtracts the value of the one byte of data retrieved from the SRNT 115 from the RNT byte pointer 321 at 851.

From either 851 or 854, the data encryption processing unit 303 adds the value of the RNT randomizer 318 to the value of the RNT byte pointer 321 at 857, which is then stored as the RNT byte pointer 321. At 860, the data encryption processing unit 303 determines whether the updated value of the RNT byte pointer 321 is greater than the sum of the RNT address pointer 315 and the predetermined size of SRNT 115. In other words, the data encryption processing unit 303 determines whether the RNT byte pointer 321 points to a memory address that is beyond the end byte of the SRNT 115. If, at 860, the data encryption processing unit 303 determines that the RNT byte pointer 321 is greater than the sum of the RNT address pointer 315 and the predetermined size of SRNT 115, then the “YES” branch is followed to 863 where the data encryption processing unit 303 subtracts the value of the predetermined size of the SRNT 115 from the RNT byte pointer 321. The method 800 then returns to 830, described above.

If, however, at 860 the data encryption processing unit 303 determines that the RNT byte pointer 321 is not greater than the sum of the RNT address pointer 315 and the predetermined size of SRNT 115, then the “NO” branch is followed to 866 where the data encryption processing unit 303 determines whether the RNT byte pointer 321 is less than the value of the RNT address pointer 315. In other words, the data encryption processing unit 303 determines whether the RNT byte pointer 321 points to a memory address located before the beginning byte of the SRNT 115. If, at 866, the data encryption processing unit 303 determines that the RNT byte pointer 321 is less than the value of the RNT address pointer 315, then the “YES” branch is followed to 869 where the data encryption processing unit 303 adds the value of the predetermined size of the SRNT 115 to the RNT byte pointer 321. The method 800 then returns to 830, described above. If, however, at 866 the data encryption processing unit 303 determines that the RNT byte pointer 321 is not less than the value of the RNT address pointer 315, then the “NO” branch is followed to 830, described above.

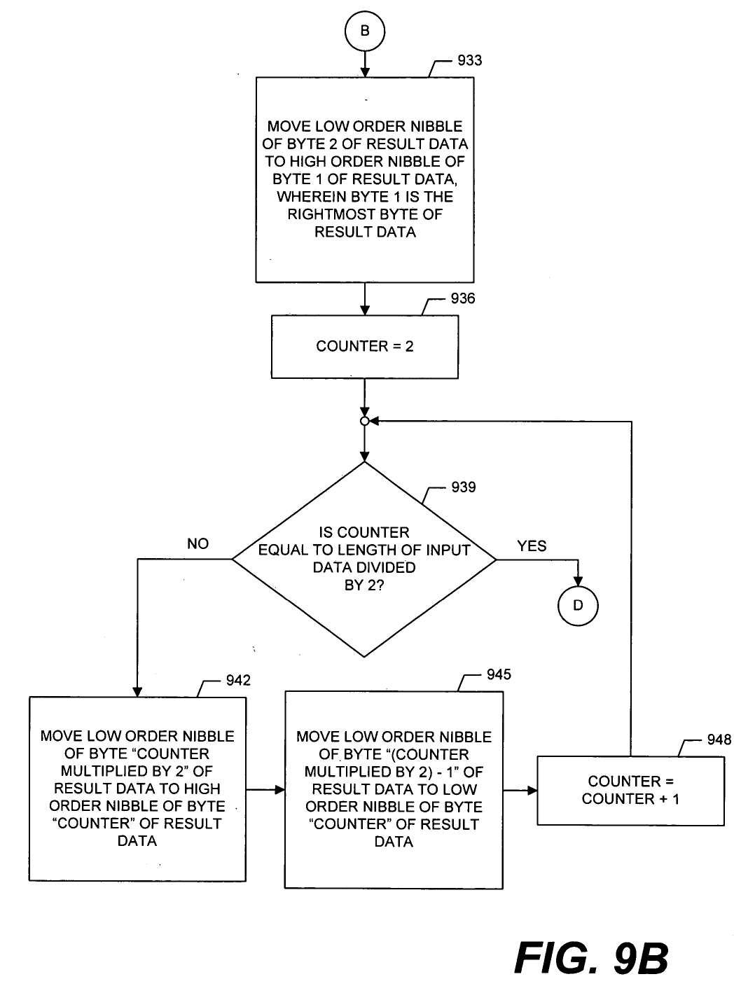

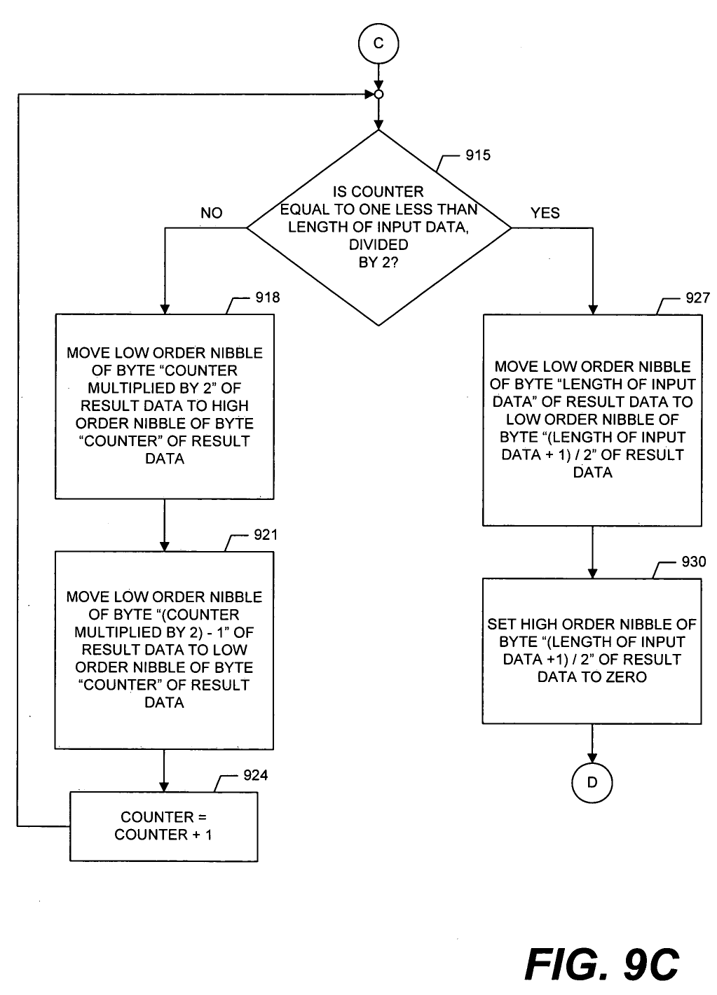

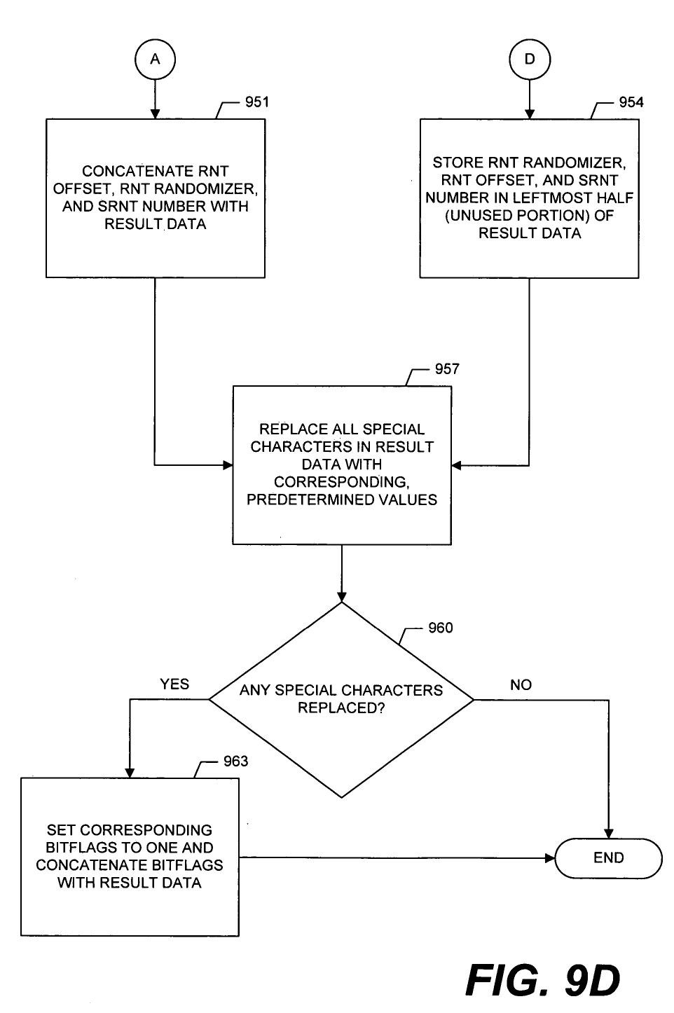

FIGS. 9A-9D, collectively known as FIG. 9, display a logic flow diagram representing a method 900 of formatting data after encryption in accordance with some embodiments of the present invention. As described above with reference to FIG. 8C, the data encryption processing unit 303 formats the result of the XOR operation before storing the formatted result in the store data storage unit 306. If the received input data comprised numeric characters, then the high order nibbles of the encrypted data may be ignored; allowing the encrypted data to be “funny packed.”

The method 900 of formatting data after encryption begins at 903 where the data encryption processing unit 303 determines whether the original plain-text input data comprised numeric characters. If at 903 the data encryption processing unit 303 determines that the original plain-text input data comprised numeric characters, then “YES” branch is followed to 906 where the data encryption processing unit 303 determines whether the byte length of the encrypted input data is an even value.

If, at 906, the data encryption processing unit 303 determines that the byte length of the encrypted input data is an even value, then the “YES” branch is followed to 933 where the data encryption processing unit 303 shifts the low order nibble of byte 2 (counting from right to left) of the encrypted input data to the high order nibble of byte 1 (counting from right to left) of the encrypted input data. Next, at 936, data encryption processing unit 303 sets a counter variable with an initial value of two (2). Then, at 939, the data encryption processing unit 303 determines whether the value of the counter variable is equal to the length of the encrypted input data divided by two.

If, at 939, the data encryption processing unit 303 determines that the value of the counter variable is equal to the length of the encrypted input data divided by two, then the “YES” branch is followed to 954 where the data encryption processing unit 303 stores the RNT randomizer 318, the RNT offset 312, and the store RNT number 118 in the leftmost half (the unused portion) of the shifted encrypted input data. If the leftmost half of the shifted encrypted input data is not large enough to store the RNT randomizer 318, the RNT offset 312, and the store RNT number 118, then such data is concatenated to the front of the shifted encrypted input data. Next, at 957, the data encryption processing unit 303 replaces all special characters within the shifted encrypted input data with predetermined corresponding replacement values. Then, at 960, the data encryption processing unit 303 determines whether any special characters have been replaced in the shifted encrypted input data. If, at 960, the data encryption processing unit 303 determines that no special characters have been replaced, then the data encryption processing unit 303 terminates operation. If, however, at 960 the data encryption processing unit 303 determines that special characters have been replaced, then the “YES” branch is followed to 963 where the data encryption processing unit 303 sets a corresponding bit flag for each byte of the shifted encrypted input data where a special character has been replaced. After concatenating the input data with the RNT offset 312, the RNT randomizer 318, and the store RNT number 118A-118N, the bit flags which represent special characters which have been replaced by predefined replacement values is also concatenated with the input data. The data encryption processing unit 303 then terminates operation.

Returning to 939, if the data encryption processing unit 303 determines that the value of the counter variable does not equal the length of the encrypted input data divided by two, then the “NO” branch is followed to 942 where the data encryption processing unit 303 alters the encrypted input data by shifting the low order nibble of the byte numbered with the value of the counter multiplied by two, to the high order nibble of the byte numbered with the value of the counter. For example and not limitation, if the counter equals four (4), then the data encryption processing unit 303 alters the encrypted input data by shifting the low order nibble of byte 8 (counting from right to left) to the high order nibble of byte 4 (counting from right to left). Next, at 945, the data encryption processing unit 303 alters the encrypted input data by shifting the low order nibble of the byte numbered with the value of one less than the value of the counter multiplied by two, to the low order nibble of the byte numbered with the value of the counter. For example, and not limitation, if the counter equals four (4), then the data encryption processing unit 303 alters the encrypted input data by shifting the low order nibble of byte 7 (counting from right to left) to the low order nibble of byte 4 (counting from right to left). Then, at 948, the data encryption processing unit 303 increments the value of the counter by one. The method 900 then returns to 939, described above.

Returning to 906, if the data encryption processing unit 303 determines that the length of the encrypted data is not an even value, then the “NO” branch is followed to 909 where the data encryption processing unit 303 moves the low order nibble of byte 2 (counting from right to left) of the encrypted input data to the high order nibble of byte 1 (counting from right to left) of the encrypted input data. Next, at 912, data encryption processing unit 303 sets a counter variable to an initial value of two (2). Then, at 915, the data encryption processing unit 303 determines whether the value of the counter variable is equal to one less than the length of the encrypted input data divided by two.

If, at 915, the data encryption processing unit 303 determines that the value of the counter variable is equal to one less than the length of the encrypted input data divided by two, then the “YES” branch is followed to 927 where the data encryption processing unit 303 alters the encrypted input data by shifting the low order nibble of the byte numbered with the value equal to the length of the input data, to the low order nibble of the byte numbered with the value equal to half of one greater than the length of the input data. For example, and not limitation, if the length of the input data is fifteen (15), then the data encryption processing unit 303 alters the encrypted input data by shifting the low order nibble of byte 15 (counting from right to left) to the low order nibble of byte 8 (counting from right to left). Then, at 930, the data encryption processing unit 303 sets the high order nibble of the byte numbered with the value equal to half of one greater than the length of the input data, to zero. For example, and not limitation, if the length of the input data is fifteen (15), then the data encryption processing unit 303 sets the high order nibble of byte 8 (counting from right to left) to zero. The method 900 then proceeds to 954, described above.

If, however, at 915 the data encryption processing unit 303 determines that the value of the counter is not equal to one less than the length of the encrypted input data divided by two, then the “NO” branch is followed to 918 where the data encryption processing unit 303 alters the encrypted input data by shifting the low order nibble of the byte numbered with the value equal to twice the value of the counter, to the high order nibble of the byte numbered with the value equal to the value of the counter. For example, and not limitation, if the counter equals four (4), then the data encryption processing unit 303 alters the encrypted input data by shifting the low order nibble of byte 8 (counting from right to left) to the high order nibble of byte 4 (counting from right to left). Next, at 921, the data encryption processing unit 303 alters the encrypted input data by shifting the low order nibble of the byte numbered with the value equal to one less than twice the value of the counter, to the low order nibble of the byte numbered with the value equal to the value of the counter. For example, and not limitation, if the counter equals four (4), then the data encryption processing unit 303 alters the encrypted input data by shifting the low order nibble of byte 7 (counting from right to left) to the low order nibble of the byte 4 (counting from right to left). Then, at 924, the data encryption processing unit 303 increments the value of the counter by one. The method 900 then proceeds to 915, described above.

Returning to 903, if the data encryption processing unit 303 determines that the original plain-text input data did not comprise numeric characters, then the “NO” branch is followed to 951 where the data encryption processing unit 303 concatenates the encrypted input data with the RNT offset 312, the RNT randomizer 318, and the store RNT number 118A-118N. The method 900 then proceeds to 957, described above.

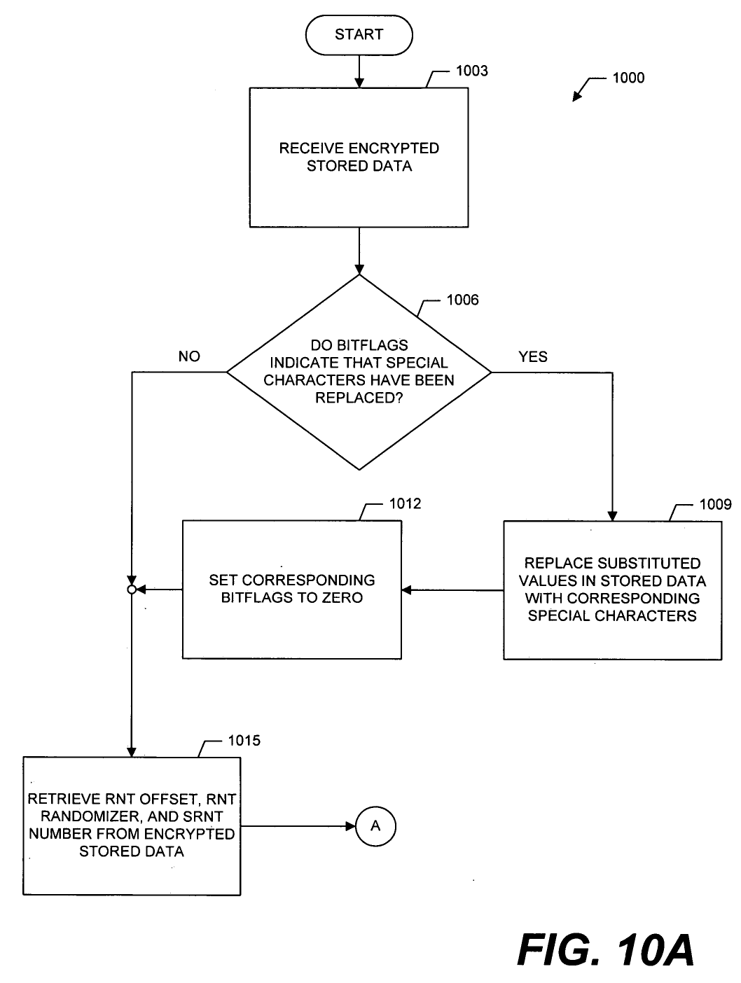

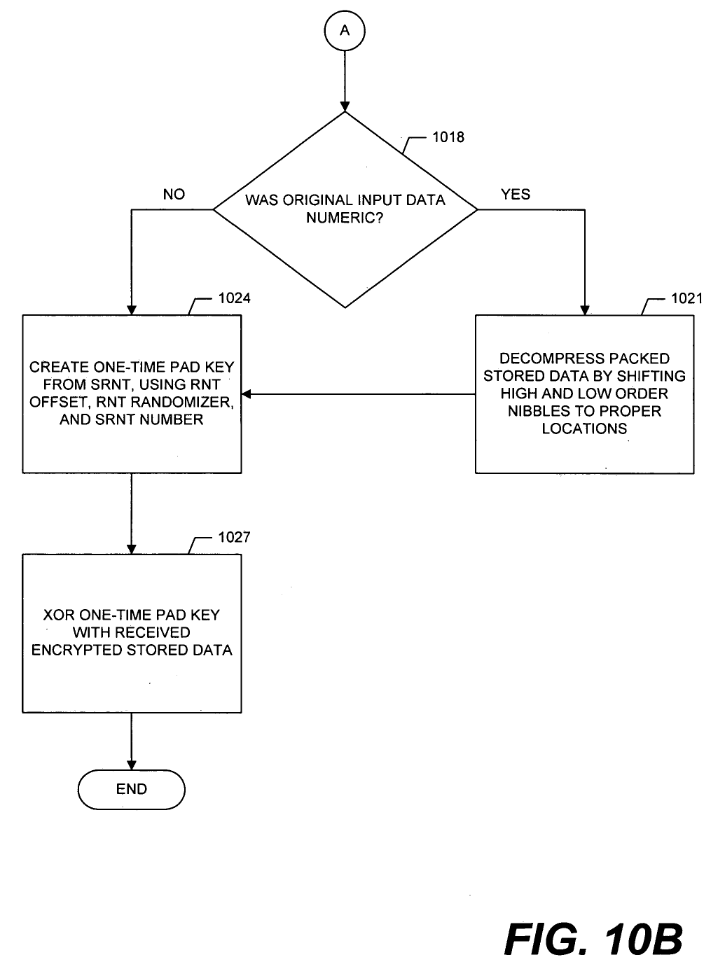

FIGS. 10A-10B, collectively known as FIG. 10, display a logic flow diagram representing a method 1000 of decrypting stored data utilizing a one-time pad key 309 in accordance with some embodiments of the present invention. The data encryption processing unit 303 decrypts the encrypted data stored in the store data storage unit 306 by reversing the steps necessary to encrypt the original input data.

The method 1000 of decrypting stored data utilizing a one-time pad key 309 begins at 1003 where the data encryption processing unit 303 receives encrypted stored data from the store data storage unit 306. Next, at 1006, the data encryption processing unit 303 determines whether the bit flags of the stored data indicate that special characters have been replaced. If, at 1006, the data encryption processing unit 303 determines that the bit flags of the stored data indicate that special characters have been replaced, then the “YES” branch is followed to 1009, where the data encryption processing unit 303 replaces all of the bytes in the stored data where special characters have been replaced with the corresponding special characters. The data encryption processing unit 303 uses the bit flags of the stored data to determine which bytes of the stored data have been replaced with the predetermined replacement values (e.g., during encryption all special characters were replaced with replacement values and a corresponding bit flag was set). Next, at 1012, the data encryption processing unit 303 sets each bit flag to zero (e.g., turns the correct bit flags off) that indicated that a special character had been replaced.

Next, at 1015, the data encryption processing unit 303 retrieves the RNT offset 312, the RNT randomizer 318, and the store RNT number 118 from the encrypted stored data. At 1018, the data encryption processing unit 303 determines whether the original input data comprised numeric characters. The data encryption processing unit 303 may determined whether the original input data comprised numeric characters by evaluating whether the encrypted stored data has been “funny packed” (e.g., whether the low order nibbles of each byte have been shifted as far right as possible, while the high order nibbles have been ignored). If, at 1018, the data encryption processing unit 303 determines that the original input data comprised numeric characters, then the “YES” branch is followed to 1021 where the data encryption processing unit 303 decompresses (or unpacks) the encrypted stored data by shifting the high and low order nibbles back to the proper locations (e.g., back to the appropriate low order nibble locations). The data encryption processing unit 303 may then add the appropriate value to the high order nibbles of the encrypted value, adding either a “3” if the value is represented in ASCII format or an “F” if the value is represented in EBCDIC format.

Next, at 1024, the data encryption processing unit 303 uses the RNT offset 312 and the RNT randomizer 318 to generate a one-time pad key 309 from the SRNT 115 identified by the store RNT number 118. Creation of the one-time pad key 309 using the RNT offset 312, the RNT randomizer 318, and the store RNT number 118 is described in more detail above with reference to FIGS. 8A-8E. Then, at 1027 the data encryption processing unit 303 applies an XOR operation to the modified encrypted stored data and the one-time pad key 309. The result is the originally received input data that was previously encrypted using the one-time pad key 309. The data encryption processing unit 303 then terminates operation in accordance with method 1000.

If, however, at 1018, the data encryption processing unit 303 determines that the original input data did not comprise numeric characters, then the “NO” branch is followed to 1024, described above.

If, however, at 1006, the data encryption processing unit 303 determines that the bit flags of the stored data do not indicate that special characters have been replaced, then the “NO” branch is followed to 1015, described above.

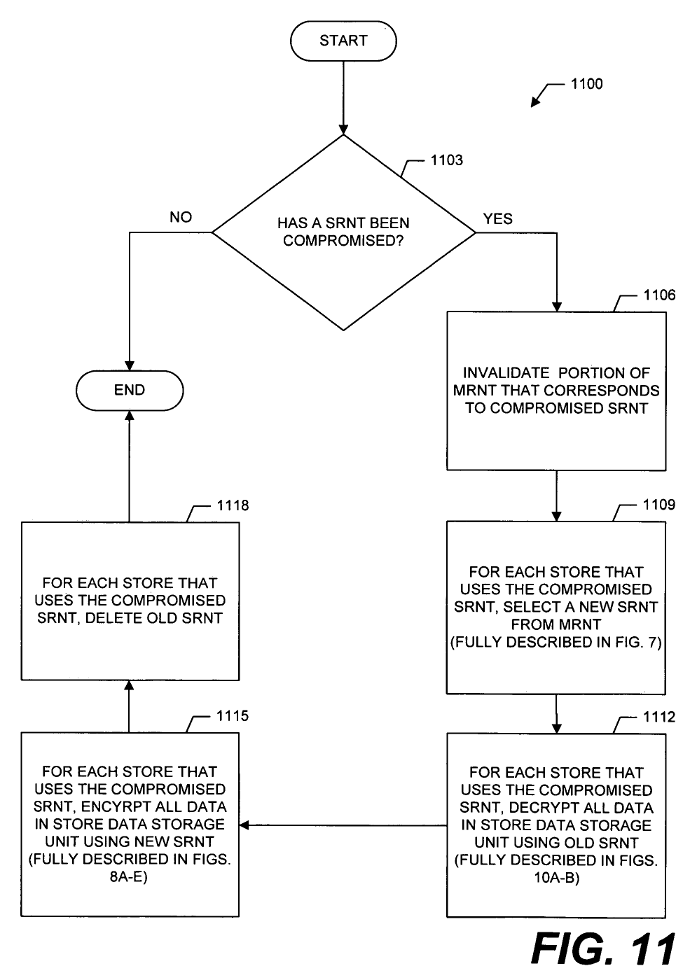

FIG. 11 displays a logic flow diagram representing a method 1100 of invalidating a store random number table 115 in accordance with some embodiments of the present invention. Each communication device 106A-106N may represent a store utilizing a point of sale device which collects account data or credit card numbers. As described above, the SRNT 115A-115N for each communication device 106A-106N is chosen randomly from the MRNT 130. Consequently, there may exist a communication device 106A-106N using the same SRNT 115A-115N as another communication device 106A-106N. If the SRNT 115A-115N at one communication device 106A-106N has been comprised, then the subset 403A-403N in the MRNT 130 corresponding to the compromised SRNT 115A-115N should be invalidated. Additionally, all communication devices 106A-106N using the compromised SRNT 115A-115N should retrieve a new SRN 115A-115N from the MRNT 130 of the data center 109.

The method 1100 for invalidating an SRNT 115A-115N begins at 1103 where a determination is made whether one of the SRNTs 115-115N has been compromised. If, at 1103, it is determined that no SRNT 115A-115N has been compromised, then the process of invalidating an SRNT 115A-115N terminates operation. If, however, at 1103 it is determined that a SRNT 115A-115N has been comprised, then the “YES” branch is followed to 1106 where the subset 403 within MRNT 130 that represents the compromised SRNT 115 is invalidated. Next, at 1109, each communication device 106A-106N that uses the compromised SRNT 115 must select a new SRNT 115 from the MRNT 130. The creation of a new SRNT 115 is fully described above with reference to FIG. 7.

Next, at 1112, each communication device 106A-106N that was using the compromised SRNT 115A-115N decrypts all of the data stored in the store data storage unit 306 using the compromised SRNT 115A-115N. The decryption of stored data is fully described above with reference to FIGS. 10A-B. Then, at 1115, each communication device 106A-106N that was using the compromised SRNT 115A-115N encrypts all of the data that was stored in the data storage unit 306 using the newly acquired SRNT 115A-115N. Then encryption of data is fully described above with reference to FIG. 8. The newly encrypted data may then be stored in the store data storage unit 306.

At 1118, each communication device 106A-106N that was using the compromised SRNT 115A-115N deletes the compromised SRNT 115A-115N. The newly acquired SRNT 115A-115N may be encrypted using the store encryption key 121A-121N and then stored in non-volatile memory of the communication device 106A-106N. The process of invalidating a store random number table 115A-115N then terminates in accordance to method 1100.

Whereas the present invention has been described in detail it is understood that variations and modifications can be effected within the spirit and scope of the invention, as described herein before and as defined in the appended claims. The corresponding structures, materials, acts, and equivalents of all mean-plus-function elements, if any, in the claims below are intended to include any structure, material, or acts for performing the functions in combination with other claimed elements as specifically claimed.

What is claimed is:

1. A method of encrypting data, comprising:
generating a first random number having a first predetermined number of bytes;
extracting a portion of the first random number, wherein the extracted portion has a second predetermined number of bytes;
generating an encryption key from the extracted portion of the first random number, wherein the encryption key includes a plurality of subsets of the extracted portion of the first random number; and
creating an encrypted value by applying an XOR operation to the encryption key and the data.

2. The method of claim 1, wherein extracting a portion of the first random number comprises:
generating a second random number, wherein the second random number has a value between zero and one less than the first predetermined number of bytes divided by the second predetermined number of bytes; and
retrieving the portion of the first random number, wherein the location of the first byte of the portion of the first random number corresponds to the value of the second random number.

3. The method of claim 2, wherein generating an encryption key from the extracted portion of the first random number comprises:
generating a third random number, wherein the third random number has a value between zero and one less than the second predetermined number of bytes;
generating a fourth random number having a value between zero and one less than a predetermined data length;
creating a first pointer, wherein the first pointer corresponds to the value equal to the sum of the third random number and a memory address of the first byte of the extracted portion of the first random number;
extracting a first subset of the extracted portion of the first random number, wherein the first byte of the first subset corresponds to the first pointer and having a length equal to a predetermined offset value;
calculating a high order nibble by applying an XOR operation to the first subset and the fourth random number;
if the high order nibble is EVEN, then creating a second pointer by subtracting a second offset value from the first pointer; and
if the high order nibble is ODD, then creating a second pointer by adding the second offset value to the first pointer;
extracting a second subset of the extracted portion of the first random number, wherein the first byte of the second subset corresponds to the second pointer and having a length equal to the predetermined offset value; and
concatenating the first subset and the second subset.

4. The method of claim 3, further comprising:
if the value of the second pointer is greater than the second predetermined number of bytes, then subtracting the value of the second predetermined number of bytes from the second pointer; and
if the value of the second pointer is less than the location of the first byte of the extracted portion of the first random number, then adding the value of the second predetermined number of bytes to the second pointer.

5. The method of claim 3, further comprising:
formatting the encrypted value to include the second random number, the third random number, and the fourth random number.

6. The method of claim 5, wherein formatting the encrypted value comprises:
shifting a low order nibble of a first byte of the encrypted value to a high order nibble of a second byte of the encrypted value; and
shifting a low order nibble of a third byte of the encrypted value to the low order nibble of the first byte of the encrypted value.

7. The method of claim 6, wherein formatting the encrypted value further comprises:
substituting a special character within the encrypted value with a corresponding predetermined value; and
marking a bit flag indicating that the special character has been substituted with the corresponding predetermined value.

8. A method for decrypting encrypted data, comprising:
extracting a plurality of numeric values from the encrypted data;
generating an encryption key from a random number table having a predetermined number of bytes, wherein the encryption key includes a plurality of subsets of the random number table and each of the plurality of subsets are selected using each of the plurality of numeric values; and
creating a decrypted value by applying an XOR operation to the encryption key and the encrypted data.

9. The method of claim 8, wherein generating an encryption key from a random number table comprises:
creating a first pointer, wherein the first pointer corresponds to the value equal to the sum of a first numeric value of the plurality of numeric values and a memory address of the first byte of the random number table;
extracting a first subset of the random number table identified by a third numeric value of the plurality of numeric values, wherein the first byte of the first subset corresponds to the first pointer and having a length equal to a predetermined offset value;
calculating a high order nibble by applying an XOR operation to the first subset and a second numeric value of the plurality of numeric values;
if the high order nibble is EVEN, then creating a second pointer by subtracting the predetermined number of bytes of the random number table from the first pointer; and
if the high order nibble is ODD, then creating a second pointer by adding the predetermined number of bytes of the random number table to the first pointer;
extracting a second subset of the random number table, wherein the first byte of the second subset corresponds to the second pointer and having a length equal to the predetermined offset size; and
concatenating the first subset and the second subset.

10. The method of claim 9, further comprising:
if the value of the second pointer is greater than the predetermined offset value, then subtracting the predetermined offset value from the second pointer; and
if the value of the second pointer is less than the location of the first byte of the random number table, then adding the predetermined offset value to the second pointer.

11. The method of claim 9, further comprising:
shifting a high order nibble of a first byte of the encrypted data to a low order nibble of a second byte of the encrypted data; and
shifting a low order nibble of a third byte of the encrypted data to a low order nibble of a fourth byte of the encrypted data.

12. The method of claim 9, wherein formatting the encrypted value further comprises:
substituting a predetermined value within the encrypted data with a corresponding special character; and
marking a bit flag indicating that the predetermined value has been substituted with the corresponding special character.

13. A system for encryption of data, comprising:
a random number generator for generating a first random number having a predetermined number of bytes; and
a data encryption processing unit adapted to extract a portion of the first random number, create an encryption key from the extracted portion of the first random number, and apply an XOR operation to the encryption key and the data;
wherein the extracted portion has a second predetermined number of bytes and the encryption key includes a plurality of subsets of the extracted portion of the first random number.

14. The system of claim 13, wherein the random number generator is further adapted to generate a second random number, wherein the second random number has a value between zero and one less than the first predetermined number of bytes divided by the second predetermined number of bytes.

15. The system of claim 14, wherein the data encryption processing unit is further adapted to extract the portion of the first random number at a location corresponding to the second random number.

16. The system of 15, further comprising:
a random number table (RNT) pointer adapted to point to a particular byte of the extracted portion of the first random number, wherein the RNT pointer initially corresponds to the value equal to the sum of a third random number generated by the random number generator and a memory address of the first byte of the extracted portion of the first random number.

17. The system of claim 16, wherein the third random number has a value between zero and one less than the second predetermined number of bytes.

18. The system of claim 16, wherein the data encryption processing unit is further adapted to extract a first subset of the extracted portion of the first random number having a first byte that corresponds to the RNT pointer.

19. The system of claim 18, wherein the data encryption processing unit is further adapted to calculate a Boolean value by applying an XOR operation to the first subset and a fourth random number generated by the random number generator, wherein the fourth random number has a value between zero and one less than a predetermined data length.

20. The system of claim 19, wherein the data encryption processing unit is further adapted to subtract an offset value from the RNT pointer if the Boolean value is TRUE and add the offset value to the RNT pointer if the Boolean value is FALSE.

21. The system of claim 20, wherein the data encryption processing unit is further adapted to extract a second subset of the extracted portion of the random number and create the encryption key by concatenating the first subset with the second subset, wherein the first byte of the second subset corresponds to the RNT pointer.

22. A computer-readable medium for encrypting data having computer executable instructions for performing steps comprising:
generating a first random number having a first predetermined number of bytes;
extracting a portion of the first random number, wherein the extracted portion has a second predetermined number of bytes;
generating an encryption key from the extracted portion of the first random number, wherein the encryption key includes a plurality of subsets of the extracted portion of the first random number; and
creating an encrypted value by applying an XOR operation to the encryption key and the data.

23. The computer-readable medium of claim 22, wherein extracting a portion of the first random number comprises:
generating a second random number, wherein the second random number has a value between zero and one less than the first predetermined number of bytes divided by the second predetermined number of bytes; and
retrieving the portion of the first random number, wherein the location of the first byte of the portion of the first random number corresponds to the value of the second random number.

24. The computer-readable medium of claim 23, wherein generating an encryption key from the extracted portion of the first random number comprises:
generating a third random number, wherein the third random number has a value between zero and one less than the second predetermined number of bytes;
generating a fourth random number having a value between zero and one less than a predetermined data length;
creating a first pointer, wherein the first pointer corresponds to the value equal to the sum of the third random number and a memory address of the first byte of the extracted portion of the first random number;
extracting a first subset of the extracted portion of the first random number, wherein the first byte of the first subset corresponds to the first pointer and having a length equal to a predetermined offset value;
calculating a Boolean value by applying an XOR operation to the first subset and the fourth random number;
if the Boolean value is TRUE, then creating a second pointer by subtracting a second offset value from the first pointer; and
if the Boolean value is FALSE, then creating a second pointer by adding the second offset value to the first pointer;
extracting a second subset of the extracted portion of the first random number, wherein the first byte of the second subset corresponds to the second pointer and having a length equal to the predetermined offset value; and
concatenating the first subset and the second subset.

25. The computer-readable medium of claim 24, wherein the computer-executable instructions further comprise:
if the value of the second pointer is greater than the second predetermined number of bytes, then subtracting the value of the second predetermined number of bytes from the second pointer; and
if the value of the second pointer is less than the location of the first byte of the extracted portion of the first random number, then adding the value of the second predetermined number of bytes to the second pointer.

26. The computer-readable medium of claim 24, wherein the computer-executable instructions further comprise:
formatting the encrypted value to include the second random number, the third random number, and the fourth random number.

27. The computer-readable medium of claim 26, wherein formatting the encrypted value comprises:
shifting a low order nibble of a first byte of the encrypted value to a high order nibble of a second byte of the encrypted value; and
shifting a low order nibble of a third byte of the encrypted value to the low order nibble of the first byte of the encrypted value.

28. The computer-readable medium of claim 27, wherein formatting the encrypted value further comprises:
substituting a special character within the encrypted value with a corresponding predetermined value; and
marking a bit flag indicating that the special character has been substituted with the corresponding predetermined value.

29. A computer-readable medium for decrypting data having computer executable instructions for performing steps comprising:
extracting a plurality of numeric values from the encrypted data;
generating an encryption key from a random number table having a predetermined number of bytes, wherein the encryption key includes a plurality of subsets of the random number table and each of the plurality of subsets are selected using each of the plurality of numeric values; and
creating a decrypted value by applying an XOR operation to the encryption key and the encrypted data.

30. The computer-readable medium of claim 29, wherein generating an encryption key from a random number table comprises:
creating a first pointer, wherein the first pointer corresponds to the value equal to the sum of a first numeric value of the plurality of numeric values and a memory address of the first byte of the random number table;
extracting a first subset of the random number table identified by a third numeric value of the plurality of numeric values, wherein the first byte of the first subset corresponds to the first pointer and having a length equal to a predetermined offset value;
calculating a Boolean value by applying an XOR operation to the first subset and a second numeric value of the plurality of numeric values;
if the Boolean value is TRUE, then creating a second pointer by subtracting the predetermined number of bytes of the random number table from the first pointer; and
if the Boolean value is FALSE, then creating a second pointer by adding the predetermined number of bytes of the random number table to the first pointer;
extracting a second subset of the random number table, wherein the first byte of the second subset corresponds to the second pointer and having a length equal to the predetermined offset size; and
concatenating the first subset and the second subset.

31. The computer-readable medium of claim 30, wherein the computer-executable instructions further comprise:
if the value of the second pointer is greater than the predetermined offset value, then subtracting the predetermined offset value from the second pointer; and
if the value of the second pointer is less than the location of the first byte of the random number table, then adding the predetermined offset value to the second pointer.

32. The computer-readable medium of claim 30, wherein the computer-executable instructions further comprise:
shifting a high order nibble of a first byte of the encrypted data to a low order nibble of a second byte of the encrypted data; and
shifting a low order nibble of a third byte of the encrypted data to a low order nibble of a fourth byte of the encrypted data.

33. The computer-readable medium of claim 30, wherein formatting the encrypted value further comprises:
substituting a predetermined value within the encrypted data with a corresponding special character; and
marking a bit flag indicating that the predetermined value has been substituted with the corresponding special character.
